(19) United States
(12) Patent Application Publication
(10) Pub. No.: US 2026/0319236 A1
(43) Pub. Date: Oct. 15, 2026

(54) OBJECTIVE LENS ASSEMBLY

(71) Applicant: Cellanome, Inc., Foster City, CA (US)

(72) Inventor: Glenn CHAN, Fremont, CA (US)

(21) Appl. No.: 19/691,372

(22) Filed: May 28, 2026

Related U.S. Application Data
(63) Continuation of application No. PCT/US2024/057858, filed on Nov. 27, 2024.
(60) Provisional application No. 63/604,818, filed on Nov. 30, 2023.

(51) Int. Cl. G02B 21/02; G01N 15/01; G01N 15/1434

(52) U.S. Cl. CPC G02B 21/02; G01N 15/01; G01N 15/1434; G01N 2015/144

(57) ABSTRACT

The methods and systems described herein are directed to a microscope objective lens assembly that includes a plurality of objective lenses, an objective carrier tray for carrying the objective lenses, and an objective pickup arm. The microscope objective lens assembly can select one of the plurality of objective lenses using the objective pick arm in a precise manner for focusing on objects in a flow cell.

### CROSS-REFERENCE

This application is a continuation of International Application No. PCT/US2024/057858, filed Nov. 27, 2024, which claims the benefit of U.S. Provisional Application No. 63/604,818 filed Nov. 30, 2023, each of which are incorporated herein by reference in its entirety.

### BACKGROUND

Microfluidics has played a key role in technologies for single cell analysis, e.g. Zare et al, Annu. Rev. Biomed. Eng., 12:187-201 (2010); Valihrach et al, Int. J. Mol. Sci., 19:807(2018 ); Murphy et al, The Analyst, 18:60-80 (2017); Shinde et al, Int. J. Mol. Sci., 19:3143(2018 ); and the like. However, there are still challenges to designing fluidic and microfluidic systems that have robust and stable optic systems that can focus on one or more cells in a field of view with an option to select one of a plurality of magnifications. Many compound objective lens systems employ a rotary turret that presents challenges in alignments to viewing cells in a flow channel with precision. Rotary turrets are bulky and relatively heavy and can interfere with other optical components and pathways when switching between different objective lenses.

### SUMMARY

In various embodiments, a microscope objective lens assembly includes (a) a plurality of objective lenses, (b) an objective carrier tray, (c) a linear rail, (d) the objective pickup arm, (e) a motor, and (f) an objective focusing stage. Each of the objective lenses can have a different magnification power. The objective carrier tray can be configured to (i) hold the plurality of objective lenses, (ii) couple to a linear rail, and (iii) move along the linear rail with respect to an objective pickup arm. The linear rail can be configured to (i) couple to the objective carrier tray and (ii) hold the objective carrier tray. The objective pickup arm can be configured to (i) couple to one of the objective lenses, (ii) be in one of a lowered state and a lifted state while coupled to one of the objective lenses. The motor operationally can be coupled to the objective carrier tray to linearly move the objective carrier tray along the linear rail, but not to the objective pickup arm. The objective focusing stage can be configured to move the objective pickup arm between the lowered state and the lifted state.

In regard to the various embodiments, the objective pickup arm can be underneath one of the objective lenses while in the lifted state.

In regard to the various embodiments, the assembly can further include a drive timing belt coupled to the motor and the objective carrier tray so that the objective carrier tray linearly moves along the linear rail.

In regard to the various embodiments, the objective focusing stage can be configured to raise the pickup arm upwards by a predetermined distance when transitioning from the lowered state and the lifted state.

In regard to the various embodiments, the objective pickup arm can include a hole configured to allow light to transmit through the objective pickup arm to one of the objective lenses.

In regard to the various embodiments, the objective pickup arm can include a lateral datum bracket. The lateral datum bracket can be configured to align one of the objective lenses to a registered location.

In regard to the various embodiments, each of the objective lenses can include an objective adapter plate. The objective adapter plate can include a feature configured to cooperate with a receiving feature of the lateral datum bracket to align each of the objective lenses.

In regard to the various embodiments, the receiving feature can have a partial V-shaped structure.

In regard to the various embodiments, the objective adapter plate can be rigidly coupled to the objective lens.

In regard to the various embodiments, the objective adapter plate can be integrated to the objective lens as a single integrated component.

In regard to the various embodiments, the objective pickup arm can include a magnet, and the objective adapter plate can include a metal configured to bind to the magnet.

In regard to the various embodiments, the objective adapter plate includes a magnet configured to bind to a metal portion of the objective pick up arm.

In regard to the various embodiments, the objective carrier tray can include a bias element disposed in an opposing relationship to the receiving feature. The bias element can be configured to urge one of the objective lenses towards the lateral datum bracket when the objective arm is in the lifted state to align the lateral location of the one of the objective lenses.

In regard to the various embodiments, the objective adapter plate can include two winged sections, where the two winged sections each include a pin. Each pin of the adapter plate can mount to a corresponding hole of the objective carrier tray.

In regard to the various embodiments, the bias element can include a leaf spring.

In various embodiments, a flow cell system can include a (A) a flow cell, (B) an illumination source, and (C) a detector. The flow cell can be configured to receive a plurality of cells. The flow cell can include a first optically transparent surface, a second optically transparent surface, and a spacer layer including a cut-out region. The first optically transparent surface, the second optically transparent surface, and the cut-out region form a flow channel. The flow channel includes an inlet and an outlet. The illumination source can be configured to output light to the flow cell. The detector can be configured to receive the light from the flow cell. The detector includes a microscope objective lens assembly that includes (a) a plurality of objective lenses, (b) an objective carrier tray, (c) the linear rail, (d) the objective pickup arm, (e) a motor, and (f) an objective focusing stage. Each of the objective lenses can have a different magnification power. The objective carrier tray can be configured to (i) hold the plurality of objective lenses, (ii) couple to a linear rail, and (iii) move along the linear rail with respect to an objective pickup arm. The linear rail can be configured to (i) couple to the objective carrier tray and (ii) hold the objective carrier tray. The objective pickup arm can be configured to (i) couple to one of the objective lenses and (ii) be in one of a lowered state and a lifted state while coupled to one of the objective lenses. The motor can be operationally coupled to the objective carrier tray to linearly move the objective carrier tray along the linear rail, but not to the objective pickup arm. The objective focusing stage can be configured to move the objective pickup arm between the lowered state and the lifted state.

In regard to various embodiments of the flow cell system, the illumination source can be disposed on one side of the flow cell and the microscope objective lens assembly can be disposed on an opposing side of the flow cell.

In regard to various embodiments of the flow cell system, the objective focusing stage can be further configured to move the objective pickup arm a focusing distance closer or farther away from a cell in the flow cell while in the lifted state, wherein the predetermined distance is greater than the focusing distance.

It should be noted that the various embodiments of the microscope objective lens assembly, alone or in combination, can be implemented on the flow cell described herein. For example, a further embodiment of the present disclosure provides a microscope objective lens assembly, the assembly comprising: (a) a plurality of objective lenses, each of the objective lenses having a different magnification power; (b) an objective carrier tray configured to: (i) hold the plurality of objective lenses, and (ii) couple to a rail; (c) an objective pickup arm, wherein the objective pickup arm is configured to: (i) couple to an objective lens of the plurality of objective lenses, and (ii) move between a lowered state and a lifted state while coupled to the objective lens; and (d) a motor operationally coupled to the objective carrier tray to move the objective carrier tray along the rail, but not to the objective pickup arm.

In one aspect, the objective carrier tray is configured to move along the rail with respect to the objective pickup arm. In another aspect, the rail is configured to couple to the objective carrier tray. In a further aspect, the rail is configured to hold the objective carrier tray. In an additional aspect, the assembly further includes an objective focusing stage configured to move the objective pickup arm between the lowered state and the lifted state. In a particular aspect, the rail is linear. In another aspect, the objective pickup arm is located underneath the objective lens when moving the objective lens from the lowered state to the lifted state. In an additional aspect, the assembly further includes a drive timing belt coupled to the motor and the objective carrier tray so that the objective carrier tray moves along the rail. In a further aspect, the objective pickup arm raises upwards by a predetermined distance when transitioning from the lowered state and the lifted state. In a certain aspect, the objective pickup arm comprises a hole configured to allow light to transmit through the objective pickup arm and the objective lens coupled thereto. In an additional aspect, the objective pickup arm comprises a lateral datum bracket, and wherein the lateral datum bracket is configured to align one of the objective lenses to a registered location.

In certain aspects, each of the objective lenses includes an objective adapter plate, the objective adapter plate comprising a feature, the feature configured to cooperate with a receiving feature of the lateral datum bracket to align each of the objective lenses. In one such aspect, the receiving feature has a partial V-shaped structure. In additional aspects, the objective adapter plate is rigidly coupled to the objective lens. In further aspects, the objective adapter plate is integrated to the objective lens as a single integrated component. In certain aspects, the objective pickup arm comprises a magnet and the objective adapter plate comprises a metal configured to bind to the magnet. In particular aspects, the objective adapter plate comprises a magnet configured to bind to a metal portion of the objective pick up arm. In further aspects, the objective carrier tray comprises a bias element disposed in an opposing relationship to the receiving feature, and wherein the bias element is configured to urge one of the objective lenses towards the lateral datum bracket when the objective arm is in the lifted state to align the lateral location of the one of the objective lenses. In certain aspects, the objective adapter plate comprises two or more winged sections, wherein the two or more winged sections each comprise a pin, and wherein each pin of the objective adapter plate mounts to a corresponding hole of the objective carrier tray. In a particular aspect, the bias element includes a leaf spring.

Additional embodiments of the present disclosure provide a flow cell system comprising: (a) a flow cell configured to receive a plurality of cells, wherein the flow cell comprises: a first optically transparent surface, a second optically transparent surface, and a spacer layer including a cut-out region, wherein the first optically transparent surface, the second optically transparent surface, and the cut-out region form a flow channel, wherein the flow channel comprises an inlet and an outlet; (b) an illumination source configured to output light to the flow cell; and (c) a detector configured to receive the light from the flow cell, wherein the detector comprises a microscope objective lens assembly disclosed herein. For example, in a particular embodiment, the present disclosure provides a flow cell system comprising: (a) a flow cell configured to receive a plurality of cells, wherein the flow cell comprises: a first optically transparent surface, a second optically transparent surface, and a spacer layer including a cut-out region, wherein the first optically transparent surface, the second optically transparent surface, and the cut-out region form a flow channel, wherein the flow channel comprises an inlet and an outlet; (b) an illumination source configured to output light to the flow cell; and (c) a detector configured to receive the light from the flow cell, wherein the detector comprises a microscope objective lens assembly, the assembly comprising: (a) a plurality of objective lenses, each of the objective lenses having a different magnification power; (b) an objective carrier tray configured to: (i) hold the plurality of objective lenses, and (ii) couple to a rail; (c) an objective pickup arm, wherein the objective pickup arm is configured to: (i) couple to an objective lens of the plurality of objective lenses, and (ii) move between a lowered state and a lifted state while coupled to the objective lens; and (d) a motor operationally coupled to the objective carrier tray to move the objective carrier tray along the rail, but not to the objective pickup arm.

In a particular aspect, the objective carrier tray is configured to move along the rail with respect to the objective pickup arm. In another aspect, the rail is configured to couple to the objective carrier tray. In a further aspect, the rail is configured to hold the objective carrier tray. In an additional aspect, the assembly further includes an objective focusing stage configured to move the objective pickup arm between the lowered state and the lifted state. In a certain aspect, the rail is linear. In another aspect, the objective pickup arm is located underneath the objective lens when moving the objective lens from the lowered state to the lifted state. In an additional aspect, the assembly further includes a drive timing belt coupled to the motor and the objective carrier tray so that the objective carrier tray moves along the rail. In a further aspect, the objective pickup arm raises upwards by a predetermined distance when transitioning from the lowered state and the lifted state. In a certain aspect, the objective pickup arm comprises a hole configured to allow light to transmit through the objective pickup arm and the objective lens coupled thereto. In an additional aspect, the objective pickup arm comprises a lateral datum bracket, and wherein the lateral datum bracket is configured to align one of the objective lenses to a registered location.

In certain aspects, each of the objective lenses includes an objective adapter plate, the objective adapter plate comprising a feature, the feature configured to cooperate with a receiving feature of the lateral datum bracket to align each of the objective lenses. In one such aspect, the receiving feature has a partial V-shaped structure. In additional aspects, the objective adapter plate is rigidly coupled to the objective lens. In further aspects, the objective adapter plate is integrated to the objective lens as a single integrated component. In certain aspects, the objective pickup arm comprises a magnet and the objective adapter plate comprises a metal configured to bind to the magnet. In particular aspects, the objective adapter plate comprises a magnet configured to bind to a metal portion of the objective pick up arm. In further aspects, the objective carrier tray comprises a bias element disposed in an opposing relationship to the receiving feature, and wherein the bias element is configured to urge one of the objective lenses towards the lateral datum bracket when the objective arm is in the lifted state to align the lateral location of the one of the objective lenses. In certain aspects, the objective adapter plate comprises two or more winged sections, wherein the two or more winged sections each comprise a pin, and wherein each pin of the objective adapter plate mounts to a corresponding hole of the objective carrier tray. In a particular aspect, the bias element includes a leaf spring.

In an additional aspect, the illumination source is disposed on one side of the flow cell and the microscope objective lens assembly is disposed on an opposing side of the flow cell. In another aspect, the objective focusing stage is further configured to move the objective pickup arm a focusing distance closer or farther away from a cell in the flow cell while in the lifted state, wherein the predetermined distance is greater than the focusing distance.

In some aspects, the objective pickup arm may is configured to adopt one or more intermediate states in between the lowered and lifted states while coupled to one of the objective lenses. While the objective pickup arm is in the raised state, the objective pickup arm may move a distance that is small relative to the predetermined distance to focus the objective lens.

In some aspects, the illumination source comprises a homogenized light condenser.

In some aspects, the objective focusing stage is configured to focus the objective lens on a surface of the flow cell, such as a top or bottom surface of the flow cell or a top or bottom surface of a flow cell channel. In some aspects, the predetermined distance, i.e., the distance that the objective focusing stage raises the pickup arm when transitioning from the lowered state to the lifted state, can be greater than the focusing distance. For example, the predetermined distance may be about 5 to 40 mm and the focusing distance may be about 2 to 100 microns.

In certain aspects, the illumination source can be disposed on one side of the flow cell and the microscope objective lens assembly can be disposed on an opposing side of the flow cell. In such aspects, the illumination source can be configured to move in tandem with the microscope objective lens assembly. Alternatively or in addition thereto, the flow cell can be positioned on one or more stages configured to move the flow cell relative to the illumination source and the microscope objective lens assembly. In some aspects, the illumination source is configured to illuminate only a portion of the flow cell.

### BRIEF DESCRIPTIONS OF THE DRAWINGS

FIGS. 1A-1E illustrate embodiments for transferring liquids exposed to atmosphere to closed reaction channels of a fluidics system.

FIGS. 2A-2B illustrate in greater detail instruments which may employ the systems and methods described herein for detecting cells and synthesizing hydrogel chambers.

FIG. 3A is a photograph of various cells where some of the cells are caged into hydrogel structures and other cells are not caged and reside in the interstitial space in between the hydrogel structures.

FIG. 3B is a photograph of the various cells of shown in FIG. 3A after flowing a liquid through the flow cell without a pressure manifold that applies an overpressure while the pump moves fluid out of the channel and leaves behind a plurality of cells in the interstitial spaces.

FIG. 4A is a photograph of various cells where some of the cells are caged into hydrogel structures and other cells are not caged and reside in the interstitial space in between the hydrogel structures.

FIG. 4B is a photograph of the various cells shown in FIG. 4A after flowing a liquid through the flow cell with a pressure manifold that applies an overpressure while the pump moves fluid out of the channel. The proportion of cells left behind in the interstitial spaces was significantly less in FIG. 4B (with pressure manifold) compared to FIG. 3B (without pressure manifold).

FIG. 5A is a photograph of a flow cell having channels E and F both containing a liquid and relatively bubble free.

FIG. 5B is a photograph of the flow cell of FIG. 5A containing the liquid that was incubated at 42 °C for 90 minutes where channel F was pressurized with the pressure manifold at 5 PSI and channel E was at atmospheric pressure.

FIG. 6 is a perspective view of an objective lens assembly.

FIG. 7A is a perspective view of an objective lens and an objective pick up arm in an un-coupled state.

FIG. 7B is the perspective view of the objective lens and the objective pick up arm in a coupled state.

FIG. 8A is a top view of an objective lens disposed on an objective carrier tray where the objective adapter plate, that is coupled to an objective lens, is sandwiched between the lateral datum bracket and a bias element.

FIG. 8B is a side view of the objective lens disposed on the objective carrier tray where the objective adapter plate, that is coupled to the objective lens, is sandwiched between the lateral datum bracket and the bias element.

FIG. 8C is a front view of the objective lens disposed on the objective carrier tray with reference to the bias element.

FIG. 9A is a perspective view of the objective lens assembly where the middle objective lens is in a lowered state.

FIG. 9B is a perspective view of the objective lens assembly where the middle objective lens is in a lifted state.

FIG. 10A is a perspective view of the objective lens assembly where the leftmost objective lens is in the lowered state.

FIG. 10B is a perspective schematic of the objective lens assembly where the leftmost objective lens is in the lifted state.

FIG. 11A is a perspective schematic of the objective lens assembly where the rightmost objective lens is in the lowered state.

FIG. 11B is a perspective schematic of the objective lens assembly where the rightmost objective lens is in the lifted state.

FIG. 12A is a side view of an instrument that includes a flow cell.

FIG. 12B is another view of the instrument that was rotated by 90 degrees on the Z axis with respect to the instrument shown in FIG. 12A.

### DETAILED DESCRIPTION

The practice of the systems and methods described herein may employ, unless otherwise indicated, conventional techniques and descriptions of organic chemistry, molecular biology (including recombinant techniques), cell biology, and biochemistry, which are within the skill of the art. Such conventional techniques include, but are not limited to, preparation of synthetic polynucleotides, monoclonal antibodies, antibody display systems, cell and tissue culture techniques, nucleic acid sequencing and analysis, and the like. Specific illustrations of suitable techniques can be had by reference to the examples herein below. However, other equivalent conventional procedures can, of course, also be used. Such conventional techniques and descriptions can be found in standard laboratory manuals such as Genome Analysis: A Laboratory Manual Series (Vols. I-IV); PCR Primer: A Laboratory Manual; Retroviruses; and Molecular Cloning: A Laboratory Manual (all from Cold Spring Harbor Laboratory Press); Renault and Duchateau, Editors, Site-directed Insertion of Transgenes (Springer, Heidelberg, 2013); Lutz and Bornscheuer, Editors, Protein Engineering Handbook (Wiley-VCH, 2009); and the like. Guidance for selecting materials and components to carry out particular functions may be found in available treatises and references on scientific instrumentation including, but not limited to, Moore et al, Building Scientific Apparatus, Third Edition (Perseus Books, Cambridge, MA); Hermanson, Bioconjugate Techniques, 3rd Edition (Academic Press, 2013); and like references.

The present disclosure provides an objective lens assembly that can select from and switch between objective lenses with different magnification powers. The objective lens assembly may be incorporated within an optical system that includes optics that direct light collected from the objective lenses to a detector to generate one or more images. The optical system may also include one or more light sources, spatial light modulating devices, and optics that direct light through the objective lens to initiate a photoactivatable process such as photopolymerization, fluorescence, or photolysis. The optical system may thus collect light from and provide spatially controlled illumination to a flow cell.

Further disclosed herein are methods for preventing bubble formation in flow cells during fluid delivery. In some aspects, the methods and systems are directed to delivering fluids exposed to atmosphere, e.g. from open-air reservoirs, such as microwells, to closed reaction channels with minimal risk of inducing bubble formation in the channels. In one aspect, the method comprises transferring a liquid from a reservoir open to the atmosphere to an inlet reservoir at the inlet end of a reaction channel, after which a pressure manifold is sealingly attached to the inlet reservoir to deliver pressure to the liquids in the inlet channel and main channel. In some cases, at the outlet end main channel a pump or vacuum source draws or moves liquid through the reaction channel at a predetermined rate while at the same time the pressure manifold delivers a pressure to the inlet reservoir in excess of the ambient atmospheric pressure. In some embodiments, methods comprise a cycle of steps comprising (a) de-pressurizing a first liquid in a channel, (b) delivering a second liquid to an inlet reservoir in fluid communication with the channel so that the first and second liquids form a single liquid body, (c) pressurizing the first and second liquids, and (d) drawing at a predetermined rate the first and second liquids through the channel. In some embodiments, such liquid delivery is part of a process requiring a plurality of such transfers, in which case steps (a) to (d) may be repeated a plurality of times. In some embodiments, “de-pressurizing” means equilibrating the first liquid pressure with atmospheric pressure. In some embodiments, before de-pressuring, a first liquid is at a pressure higher than atmospheric pressure. In some embodiments, step (c) of pressurizing the first and second liquids comprises pressurizing the first and second liquid to a predetermined pressure. It should be noted that ambient pressure or ambient atmospheric pressure refers to the pressure at the location of the measurement and typically ranges from about 14.5 inches Hg to about 14.9 inches Hg (or 14.5 pounds per square inch (psi) to 14.9 pounds per square inch, and is typically about 14.7 psi).

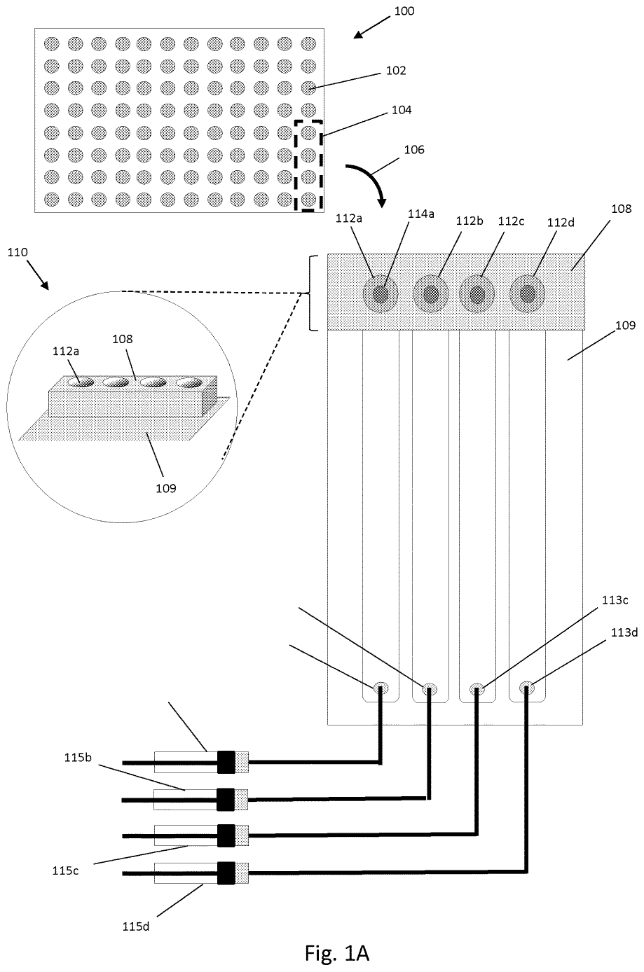

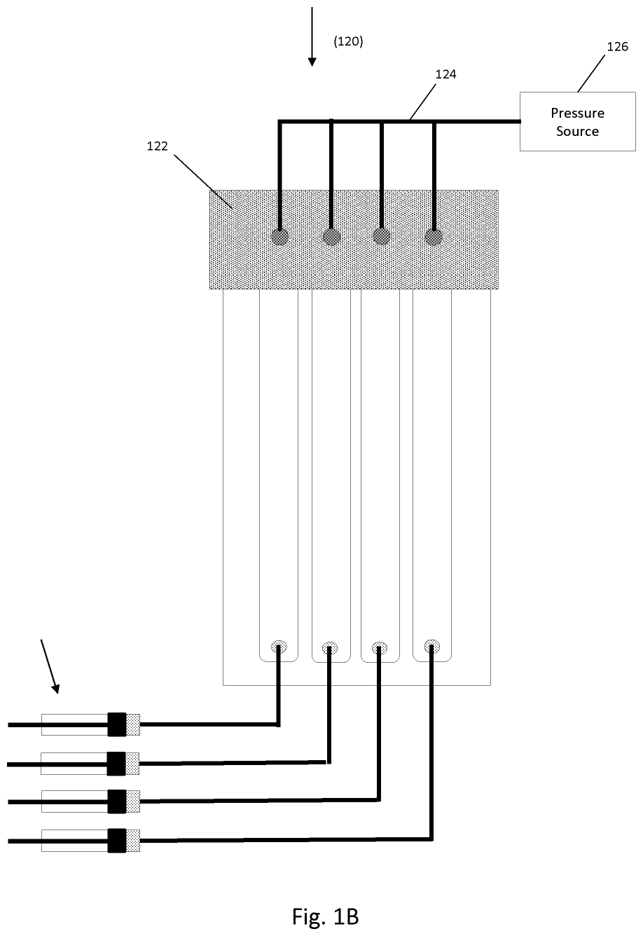

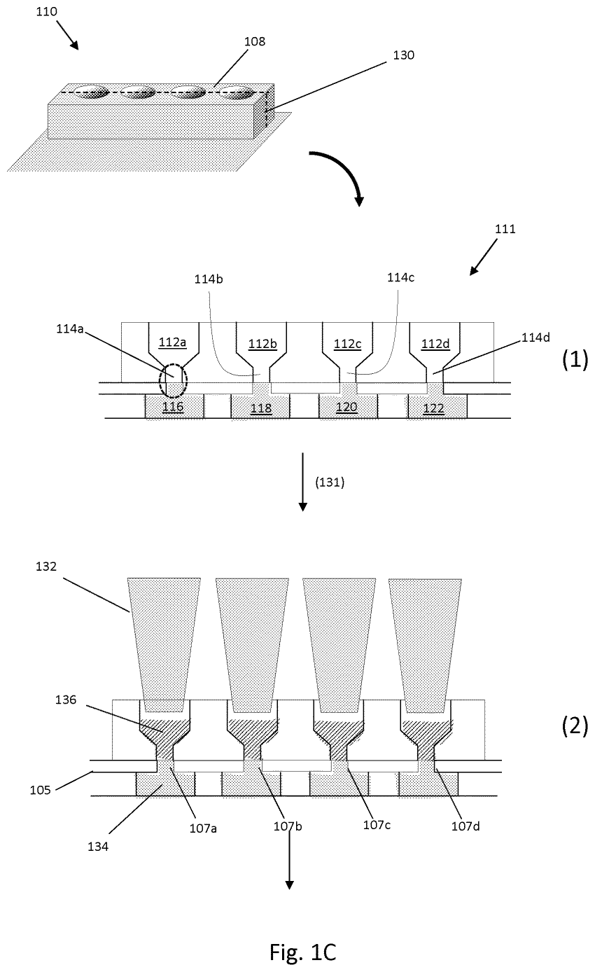

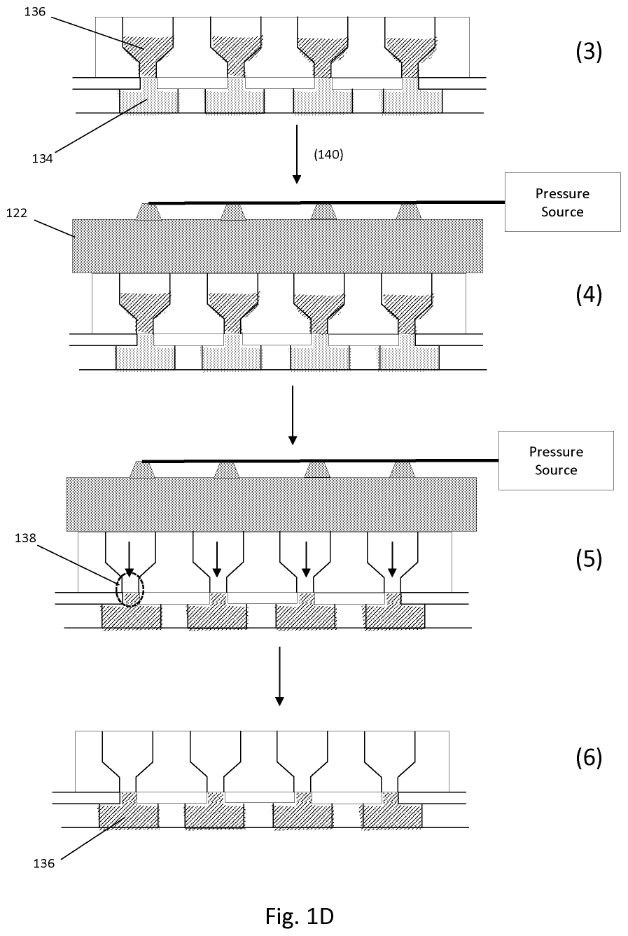

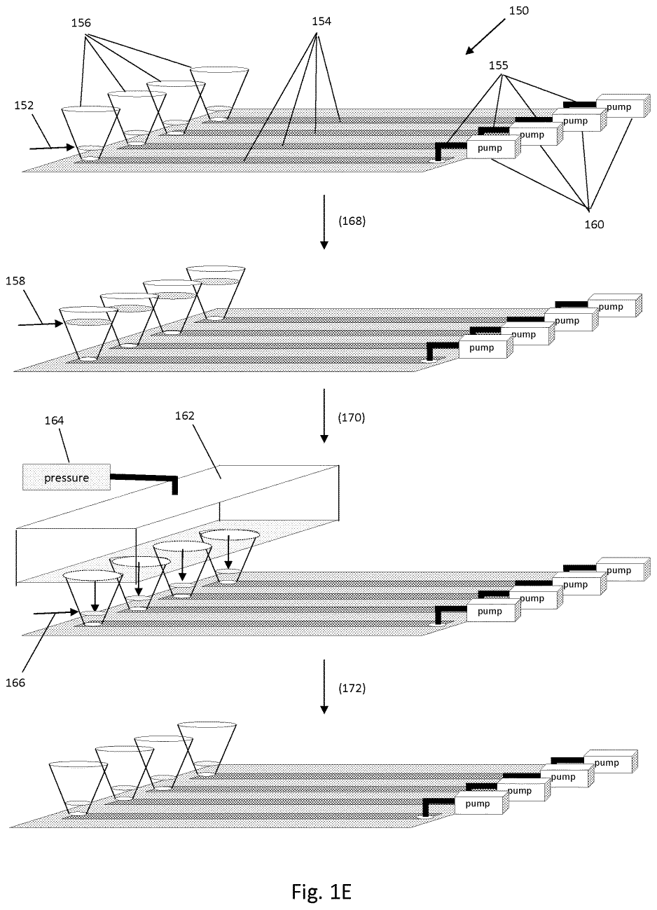

An embodiment of the method is illustrated in FIGS. 1A-1E. In these figures, flow cell (109) comprises four channels (116, 118, 120 and 122) (sometimes referred to as “main channels”) and body (108) comprising four inlet reservoirs (112a, 112b, 112c and 112d), one for each channel (116, 118, 120 and 122, respectively). However, the flow cell may have any number of channels, including one, two, three, four, five, six, seven, eight, ten, twelve, sixteen or more channels. In some embodiments, inlet reservoirs may comprise an inverted conical shape (or partial conical shape) as shown in FIG. 1C or 1E, which inlet reservoirs are in fluid communication with channels (116, 118, 120 and 122, respectively) through the narrowed portions of the inverted cones (sometimes referred to herein as the “throats” of the inlet reservoirs, e.g. 114a of FIG. 1A) and the inlets of the respective channels. Inlet reservoirs may be formed in a body, such as (108) that is bonded to, or otherwise sealingly attached to, flow cell (109). Blow-up (110) gives a three-dimensional view of these components. Flow cell (109) can further include a first surface and a second surface to form a top boundary and bottom boundary of the channels. Referring to FIG. 1C, the first surface can be in the form of a glass sheet (105) that has a plurality of inlets (107a, 107b, 107c, and 107d) for the respective channels (116, 118, 120, and 122). The plurality of inlets (107a, 107b, 107c, and 107d) can be a series of through-holes in glass sheet (105) that align with the throat regions (114a, 114b, 114c, and 114d) of the inlet reservoirs (112a, 112b, 112c, and 112d). In various embodiments, a double-sided pressure sensitive adhesive having corresponding through-holes can be used for binding the body (108) to glass sheet (105) and the corresponding inlets (107a, 107b, 107c, and 107d). Channels (116, 118, 120 and 122) can each have an outlet (113a, 113b, 113c and 113d, respectively) at an end opposite of that of the inlet reservoirs. In some embodiments, each outlet reservoir (113a, 113b, 113c and 113d) are separately connected to (and in fluid communication with) a pump (115a, 115b, 115c and 115d, respectively). In some embodiments, such pumps are precision syringe pumps that may be programmed to draw or move liquids through their respective channels a predetermined flow rate at predetermined intervals in coordination with the filling of the inlet reservoirs (that is, for example, in some embodiments, the syringe pumps are inactive whenever the inlet reservoirs are being filled). Reagent reservoirs may be wells of a microtiter plate, such as a 96-well plate (100), where each well (e.g. 102) contains a reagent and a liquid transfer system, such as an automated pipetting system (that is, a “pipettor”), transfers liquids to all the inlet reservoirs of a flow cell at the same time. For example, in the four-channel flow cell of FIG. 1A, liquids of a subset of four wells (104) may be transferred (106) at the same time to the four inlet reservoirs (112a, 112b, 112c and 112d). As illustrated in FIG. 1B, after liquids are delivered to the inlet reservoirs, pressure manifold (122) is sealingly attached to the inlet reservoirs so that pressure may be applied to the delivered liquids and liquids already in the channels. Pressure manifold (122) may be a body that sealingly attaches to body (108) containing inlet reservoirs (112a, 112b, 112c and 112d). In some embodiments, each inlet reservoir may be pressurized using a separate pressure source, or in other embodiments, a single pressure source may pressurize all of the inlet reservoirs. In some embodiments, wherein each inlet reservoir is pressurized with a separate pressure source, such pressure source may be regulated to a pressure specific for its associated channel. In some embodiments, such specific pressure may depend on the amount of fluid resistance in its associated channel. Such differences in fluid resistance may arise from different amounts of material (e.g. cells, gel microstructures, debris, and the like) in the channel. The latter embodiment is illustrated in FIG. 1B. After pressure manifold (122) is sealingly attached to the inlet reservoirs, pressure source (126) can generate a pressure (or a predetermined pressure) which is transferred to the inlet reservoirs through conduits (124) and the pressure manifold itself. In some embodiments, the predetermined pressure is in excess of atmospheric pressure. In some embodiments, the predetermined pressure may be lower than atmospheric pressure, for example, under circumstances in which liquid is caused to flow from the channels to the inlet reservoirs.

FIGS. 1C and 1D further illustrate for the above embodiment, the movement of liquids through the inlet reservoirs and channels during operation of the fluid transfer system. Cross-sectional view (111) (or panel (1)) shows inlet reservoirs and channel interiors along plane (130) transecting three-dimensional representation (110) of body (108) in which the inlet reservoirs are formed. Panels (2)-(6) present the same cross-sectional view at different steps in the fluid transfer process. Returning to panel (1), inlet reservoirs (112a, 112b, 112c and 112d) may be in fluid communication with interiors of channels (116, 118, 120 and 122, respectively) through throat regions of inlet reservoirs (114a, 114b, 114c and 114d, respectively), which each comprises the narrowed region of the inlet reservoir and the inlet of the channel (specifically shown for inlet reservoir 114a). The shaded region of the channels and channel inlets in cross-section (111) indicates the presence of a first liquid. From the configuration of cross-section (111) (i.e., first liquid in channel, inlet reservoir empty (or nearly empty)), as shown in panel (2), second fluids may be transferred (131) from an open reservoir (or reservoirs) to the open inlet reservoirs, for example, by the use of pipettes (132). After removal of pipettes (132) (panel (3)), first liquid (134) and second liquid (136) are shown may combine, or coalesce, with one another (at least locally) so that they form a single body of liquid for each channel. Pressure manifold (122) may be sealing attached (140) to inlet reservoirs (112a, 112b, 112c and 112d); a predetermined pressure may be applied to the inlet reservoirs; and pumps (115a, 115b, 115c and 115d) may be activated to begin drawing liquid through their respective channels are a predetermined rate (panels (4) and (5)). In some embodiments, the pressure is regulated if necessary to maintain the predetermined pressure as the first and second liquids are moved through the channels by the pumps. In some embodiments, the amount of liquid drawn through a channel is greater than a single channel volume. In some embodiments, the amount of liquid drawn or moved through a channel is a multiple of the channel volume. For example, the amount of liquid drawn or moved through a channel can be 2×, 3×, 4×, 5×, or 10× the channel volume. In some embodiments, the amount of liquid drawn or moved through a channel may be less than a single channel volume. The volume of the inlet reservoirs (and the volumes of liquid delivered to them) can be adjusted depending on the predetermined volumes of liquid desired to be drawn or moved through the channels. In some embodiments, the volumes of liquid delivered and the volumes of liquid drawn or moved in each cycle of steps represented in panels (1) to (6) is selected so that after liquid is drawn or moved, the resulting level of liquid in the inlet reservoir is within or above the throat region of the inlet reservoir (e.g. illustrated by (138) of panel (5) of FIG. 1D, or by (152) or (166) in FIG. 1E). Finally, as shown in panel (6), the original first liquid (shown as shaded region (134) in panel (3)) can be replaced by the new first liquid (shown as the cross-hatched region (136) in panel (6)), so that the inlet reservoirs are ready for the next cycle of liquid transfer steps.

FIG. 1E also illustrates the cycle of steps in the transfer a volume of liquid by methods described herein. Flow cell (150) is shown with inlet reservoirs (156) in fluid communication with channels (154) and pumps (160) by way of conduits (155) connecting channel outlets to pumps (160). At the beginning of a transfer cycle, level (152) of the first liquid can be in or near the throat region of the inlet reservoir or the inlet of the channel. A second liquid may be transferred (168) to the inlet reservoir, thereby raising level (158) of the combined first and second liquids in the inlet reservoir. Pressure manifold (162) (connected to pressure source (164)) may be sealingly attached (170) to the inlet reservoirs, and a predetermined pressure can be applied to the first and second liquids, after which pumps (160) are activated (170) to draw or move a predetermined volume of the first and second liquids through channels (154), thereby bringing the first and second liquid level to (166), which makes the system ready (172) for the next liquid transfer cycle.

### Applications

The reagent delivery method and system described herein may be used with a wide range of analytical devices, particularly devices for analyzing living biological materials, such as single cells, because of the susceptibility to disruption and/or distortions of measurements or manipulations by the formation and movement of bubbles. The reagent delivery method and system described herein may be particularly applicable to cell analysis systems employing gel microstructures in flow cell channels, such as described in Khurana et al, International patent publication WO2022/150659, which is incorporated herein by reference.

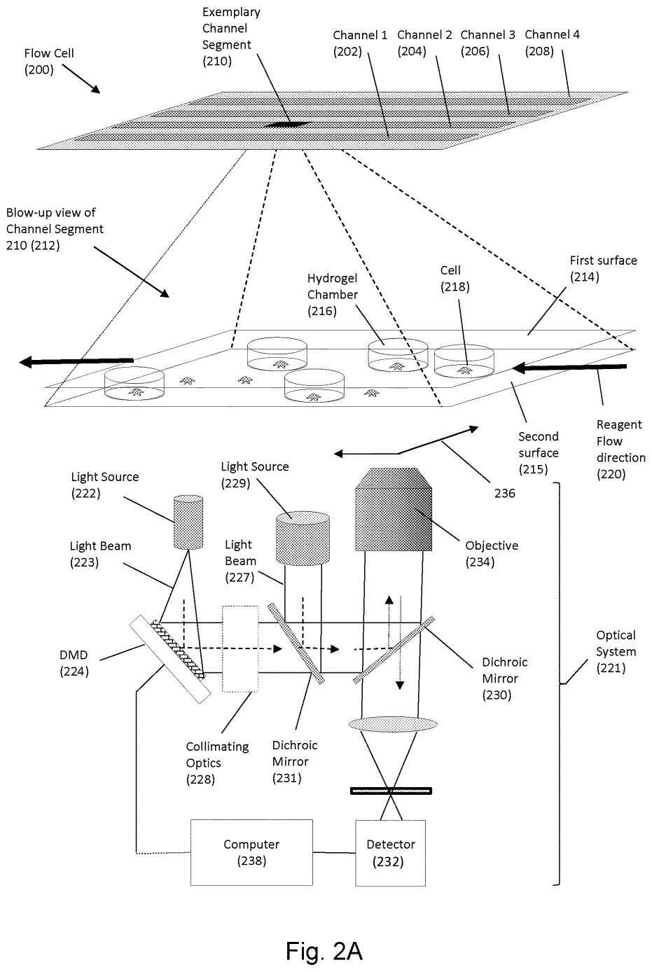

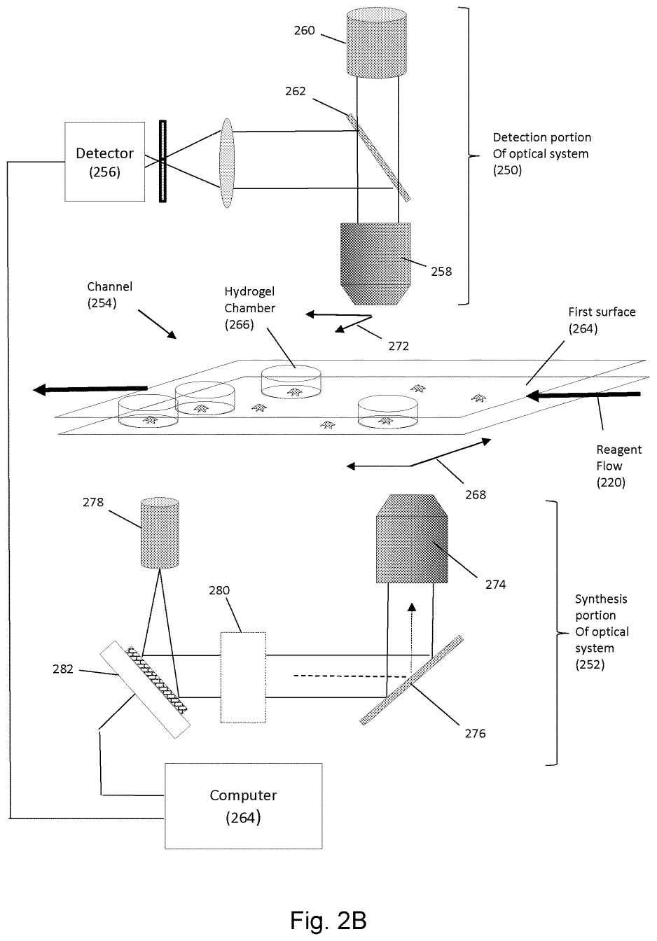

FIGS. 2A-2B illustrate channels of flow cells made and operated in accordance with Khurana et al (cited above). Flow cell (200) may be a component of a fluidic device that provides one or more channels and liquid handling components under programmable control for delivering beads and reagents to the channels. In this illustration, four channels (202, 204, 206, and 208) are shown, with blow-up view (212) of segment (210) of channel 2 (204) shown below. In the abstracted view of flow cell (200) of FIG. 2A, inlets, outlets and other features of the channels are not shown. In some embodiments, the distance between the lower surface (“first” surface, 214) and the upper surface (“second” surface, 215) (i.e., the interior height of the channels) may be in the range of from 10 μm to 500 μm, or in the range of from 50 μm to 250 μm. On first surface (214) of channel 2 (204) a plurality of cells, e.g. (218), are each enclosed by a hydrogel chamber, e.g. (216). In some cases, a portion of the plurality of cells are each enclosed by a hydrogel chamber. In some embodiments, the porosity of polymer matrix walls of the hydrogel chambers is selected to be impermeable to the cells, but permeable to reagents for forming spatial barcodes. Thus, reagents may be introduced to, and removed from, the interiors of the hydrogel chambers by flowing (220) them through the channels, but beads are retained inside. Below blow-up (212) of channel segment (210) is shown an optical system (221) for photosynthesizing hydrogel chambers at the locations of cells in the channels, for example, as disclosed in Khurana et al (cited above) and as detailed further herein using the disclosed optical systems. Optical systems with different configurations than those of FIGS. 2A and 2B may be employed for carrying out these functions. In some embodiments, one or more digital micromirror device (DMD)-objective subsystems for synthesizing hydrogel structures may be employed to increase the speed of synthesis by synthesizing multiple structures simultaneously. Examples of commercially available digital micromirror devices that are utilizable in the presently disclose optical systems are provided in Song et al, Precision Engineering, 2018; 51:729-761 and in Zhuang and Ho, Journal of Innovative Optical Health Sciences, 2020; 13(6): 2030011. One of skill in the art will appreciate that certain spatial light modulating devices other than DMDs may be used in the presently disclosed optical systems, such as liquid crystal spatial light modulators (e.g., as disclosed in Zhuang and Ho cited above), interferometric modulator displays (e.g., as disclosed in Londergan et al., Proc. Asia Displays, Shanghai, China, 2007, 107-112), grating light valves (e.g., as disclosed in Solgaard et al., Opt. Lett., 1992; 17(9): 688-690), liquid crystal on silicon (Park et al., Proc. IEEE Consumer Electron., Las Vegas, NV, USA, January 2011, 805-806), and the like.

Returning to FIG. 2A, for photosynthesizing the hydrogel chambers, light source (222) may generate a light beam (223) of appropriate wavelength light (e.g. UV light), that passes through an appropriate photo-mask or beam-shaping or beam steering (Galvo) system for shaping a beam, to synthesize a desired structure or structures in a channel. In some embodiments, a digital micromirror device (DMD) (224) is employed. In some embodiments, a physical photomask may be employed. Chamber position, shape and polymer matrix wall thickness may be determined at least in part from position information determined from images collected by detector (232). The position information can be the position of a cell, nucleic acid, or any analyte of interest. Reflected light from DMD (224) may be shaped using optics, e.g. collimating optics (228), and is directed (e.g., using one or more dichroic mirrors (231, 232)) through objective lens system (234) into channel 2 segment (210). Objective (234) and flow cell (200) can move relative to one another in the xy-directions (236) to photosynthesize chambers at any position in any of the channels. In some embodiments, flow cell (200) moves and optical system (221) is stationary. In some embodiment, objective (234) may also direct light beam (227) from light source (229) to targets, such as cells, on first surface (214) and collect optical signals, such as fluorescent signals, from assays taking place on first surface (214).

An illumination source may be positioned on an opposite side of the flow cell (200) as the optical system (221) to produce and direct light through the flow cell (200) to the objective (234). To achieve this functionality, the illumination source positioned on the opposite side of the flow cell can be configured to move in tandem with the optical system (221), or the illumination source and optical system (221) can be stationary and the flow cell (200) can be moved to adjust the portion of the flow cell (200) illuminated by the illumination source. Light from the illumination source may thus pass through the flow cell (200) for collection by the objective (234) and direction to the detector (232).

Light from the illumination source may be homogenized. The illumination source may include, for example, a homogenizer such as a light pipe homogenizer, a controlled scattering homogenizer, a random scattering diffuser, or a homogenized light condenser. As used herein, a homogenizer may be a structure that increases light intensity uniformity of light from an illumination source. Many illumination sources produce uneven (e.g., Gaussian) light intensity distributions, and are therefore unsuitable for applications that require even light intensity over large fields of view, for example for uniform quantitation or photopolymerization. An illumination source of the present disclosure may provide light with an even intensity distribution over a defined portion of a flow cell or other fluidic device. Light from the illumination source can also be condensed and optionally may be focused on the flow cell. The illumination source may optionally share a focal point with a lens of the objective lens assembly opposite the illumination source.

Alternatively, optical signal collection may be carried out with a separate objective as shown in FIG. 2B. Information collected by detector (232), or its counterpart in the embodiment of FIG. 2B, particularly cellular positions in their respective channels, may be employed by computer (238) and/or subsidiary controllers to direct DMD (224) and translation devices controlling the relative positions of objective (234) and flow cell (200) to synthesize hydrogel chambers of the appropriate shape and size at the appropriate locations.

FIG. 2B illustrate an alternative optical system in which the detection portion (250) of the optical system moves (272) independently from the movement (268) of the synthesis portion (252) of the optical system. Detection portion (250) of the optical system comprises detector (256), objective (258), light source (260) and interconnecting optical elements, such as dichroic mirror (262). As with the embodiment of FIG. 2A, detector (256) is operationally associated with computer (264) and the synthesis portion (252) of the optic system to provide synthesis portion (252) with position information. Computer (264) and (238) are also in operationally associated with stages and/or motors controlling the relative positions of the objectives of the optical systems and the position of the flow cell. In this embodiment, synthesis portion (252) of the optical system is located on the other side of first surface (264) from detection portion (250). As with the embodiment of FIG. 2A, it comprises the components objective (274), mirror (276), collimating optics (280), DMD (282) and light source (278).

Referring back to FIG. 2 and FIG. 2B, a single objective lens (234, 258) is depicted, respectively. However, under certain circumstances, it is desirable to have more than one objective lens, where each lens has a different magnification, as part of the instrument so there is increased flexibility in viewing a field of one or more cells in a flow cell. In various embodiments, objective (234, 258) can be replaced with a compound objective lens assembly that include a plurality of objective lens having a range of magnification values. A compound objective lens assembly has more than one objective lens where each one can have, for example, a 4×, 10×, and 20× magnification. Compound objective lens assembly (600) can be used with the instrument so that a particular objective lens having an appropriate magnification is selected for analyzing the one or more cells of interest. In various embodiments, the objective lens assembly is used as part of a microscope for displaying and recording images of cells in the flow cell. In various embodiments, the plurality of objective lenses can be represented by 2, 3, 4, 5, 6, 7, 8, 9, 10, or more objective lenses that are incorporated into the compound objective lens assembly as described herein.

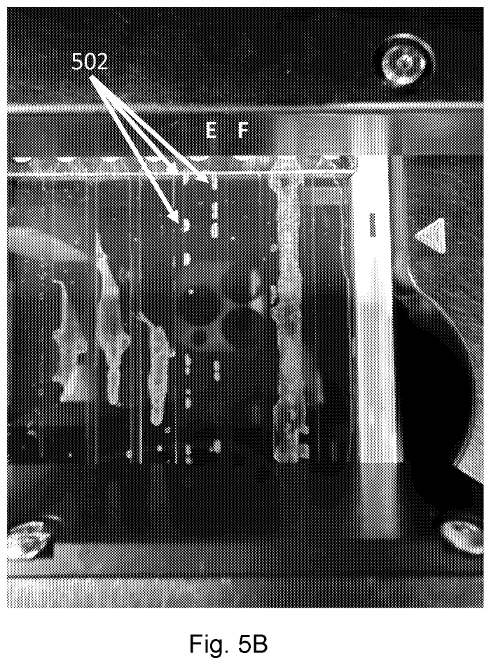

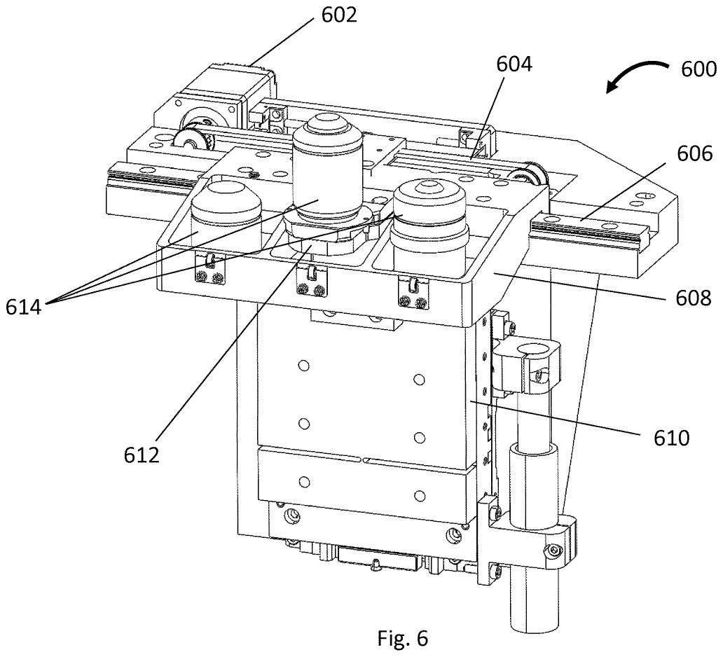

FIG. 6 is a perspective view of a compound objective lens assembly (600) that includes 3 different types of objective lenses (614) each having a different magnification. For example, the assembly can include 3 objective lenses (614) where each one has a 4×, 10×, or 20' magnification that can be selected based on the type of cellular assay being performed. The objective lens assembly (600) includes an objective carrier tray (608) that can contain all 3 of the objective lenses (614) and move them along a linear rail (606). In various embodiments, a motor (602) and a drive timing belt (604) can be used to move the objective carrier tray (608) along linear rail (606). An objective pick up arm (612) can move one of the objective lenses (614) between the lowered state and the lifted state along a Z axis from the objective carrier tray (608). It should be noted that that the objective pick up arm (612) is not configured to move along linear rail (606).

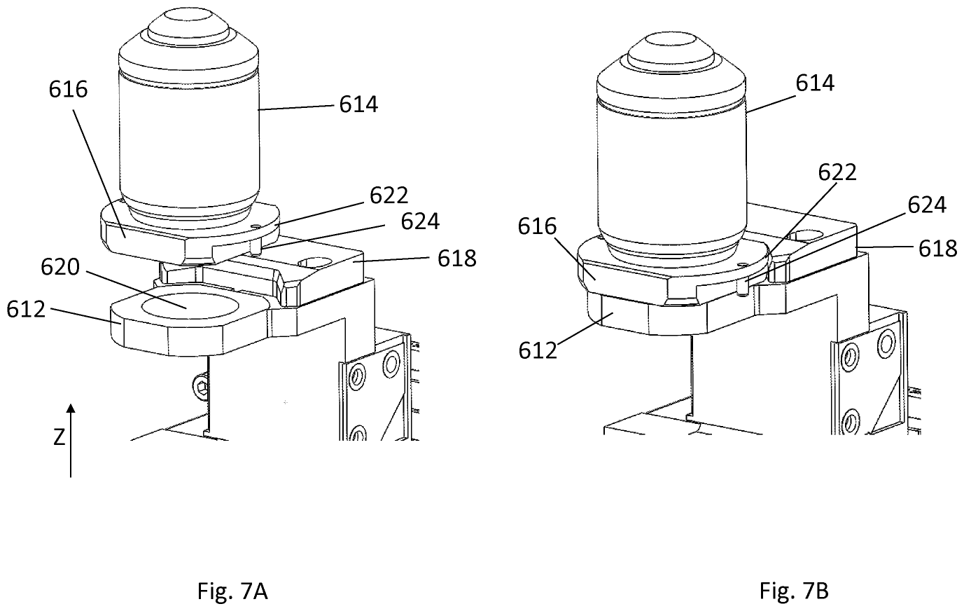

An objective lens (614) and an objective pick up arm (612) of the objective lens assembly (600) are illustrated in an un-coupled state (FIG. 7A) and in a coupled state (FIG. 7B). Objective lens (614) can include an objective adapter plate (616) that can be rigidly attached to a bottommost portion of the objective lens (614). In various embodiments, the objective adapter plate (616) can be integrated with the objective lens (614) to form a single piece. The objective adapter plate (616) can include two winged sections (622) where each winged section (622) has a pin (624) for alignment. The winged sections (622) can be configured to overhang over a portion of the objective pick up arm (612) and be at least partially supported by the objective carrier tray. The two pins (624) can be used to interact with a hole or feature in the objective carrier tray (608) and help with the positioning of objective lens (614). The objective pick up arm (612) also includes a lateral datum bracket (618) that is rigidly coupled to objective pick up arm (612). Alternatively, the shape of lateral datum bracket (618) can be integrated and formed as a singular component with the objective pick up arm (612). The lateral datum bracket (618) has a shape configured to interact with a back portion of the objective adapter plate to help align the position of the objective lens (614). In various embodiments, the objective pick up (612) arm includes a magnet and the objective adapter plate (616) comprises a metal (e.g., iron based metal) that is configured to be bound strongly to the magnet so that the objective lens does not move easily during the movement of the objective carrier tray. Objective pick up arm (612) also includes a hole (620) so that light can pass through the hole (620) to and from the objective lens (614).

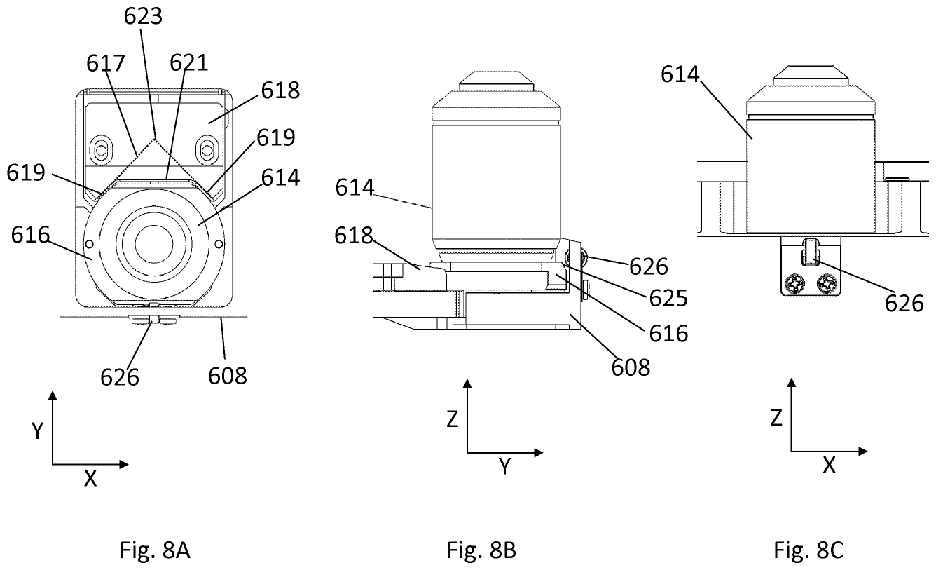

The objective adapter plate (616) is sandwiched between the lateral datum bracket (618) and a bias element (626) that is illustrated as a top view (FIG. 8A), side view (FIG. 8B), and front view (FIG. 8C). The lateral datum bracket has two partial V shape portions (619) and a straight portion (621) that are collectively configured to mate with an outer rear portion of the objective adapter plate (616) for aligning the objective lens (614). It should be noted that the two partial V shape portions (619) are arranged with an angle such that a line segment extrapolation of the two partial V shape portions will meet to form an associated vertex (623) and a full V shape (617) (exemplified by a dotted line segment). The two partial V shape portions (619) together form a partial V-shaped structure. The objective carrier tray (608) includes a bias element (626) that is disposed in an opposing relationship with respect to vertex (623) of the V shape (617) (illustrated with the dotted line segment). It should be noted that the bias element (626) and at least the partial V shape portions (619) cooperate to align the objective adapter plate and objective lens to a precise and repeatable location with respect to an X and Y axis.

Referring back to FIG. 8B, a front side of the objective adapter plate (616) includes an angled portion (625). The movement of lifting up the objective pick up arm (612) and the associated objective adapter plate (616) causes the angled portion (625) to interact with the bias element (626) that causes the objective adapter plate (616) to move along the Y axis for aligning a precise position of the objective lens (614). Although objective pick up arm (612) has a magnet that binds to the objective adapter plate (616), the bias element (626) has sufficient force to slide the objective adapter plate (616) along the Y axis for alignment while raising the objective pick up arm (612). Once the objective pick up arm (612) is above the bias element (626), where the bias element (626) no longer applies a force to the objective adapter plate (616), the objective adapter plate (616) and the objective lens (614) are both held in place based on the magnetic binding force.

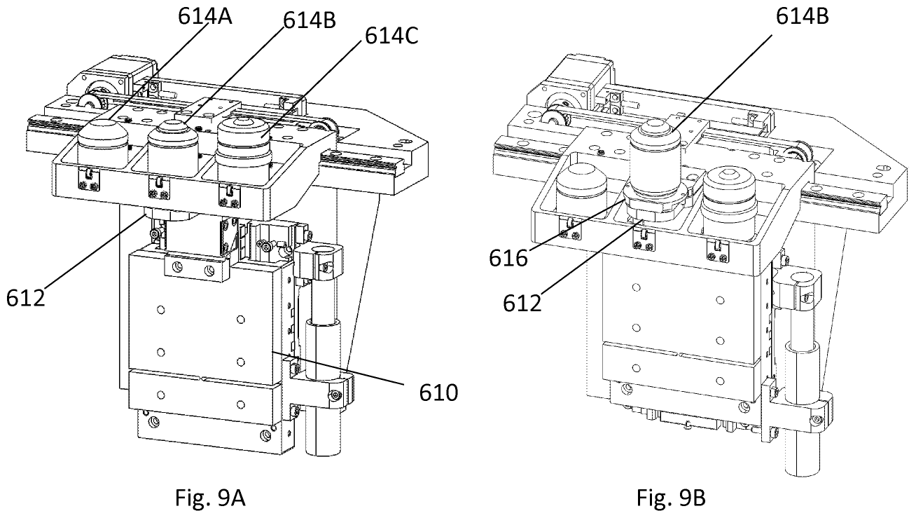

A perspective schematic of the objective lens assembly (600) is illustrated where a middle objective lens (614B) is in a lowered state (FIG. 9A) and in a lifted state (FIG. 9B). The objective pick up arm (612) can be raised upwards using the objective focusing stage (610) that disengages the objective lens (614B) from the objective carrier tray (608) and lifts the objective lens (614B) so that it can be used for imaging cells in a flow channel. The lowered state can refer to a downward position of the objective pick up arm that is below a bottom portion of the objective carrier tray so that the objective lens is at least partly supported by the objective carrier tray. The lifted state can refer to an upward position of the objective pick up arm that is above a bottom portion of the objective carrier tray so that the objective lens is raised upwards and is no longer supported by the objective carrier tray. In various embodiments, the objective focusing stage can raise the pickup arm upwards by a predetermined distance when transitioning from the lowered state and the lifted state. For example, the predetermined distance can range from about 5 mm to about 40 mm, and preferably from about 20 mm to about 30 mm.

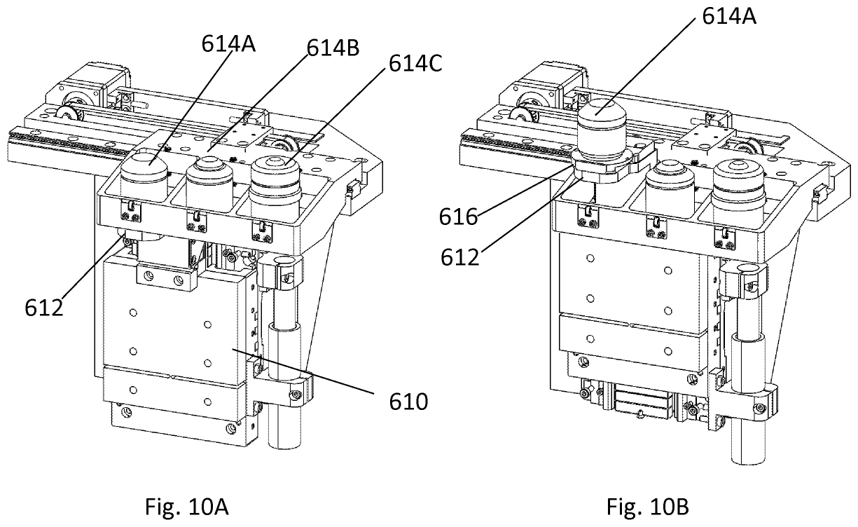

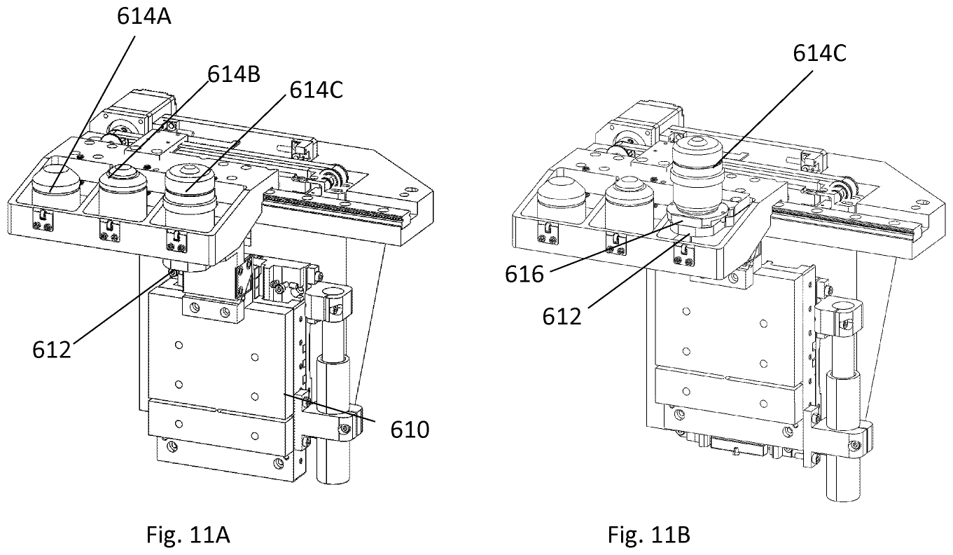

It should be noted that objective lens (614) can also be referred to as left hand side objective lens (614A), middle objective lens (614B), or right hand side objective lens (614C) with respect to FIG. 9A. With respect to the position of the objective carrier tray (608) in FIG. 9A, the objective carrier tray (608) can be moved to the right so that the objective pick up arm (612) is underneath the objective lens (614A) (see FIG. 10A). Once the objective carrier tray (608) is underneath the objective lens (614A), the pick up arm (612) can be lifted upwards (see FIG. 10B) so that objective lens (614A) can be used to view cells in the flow cell. With respect to the position of the objective carrier tray (608) in FIG. 9A, the objective carrier tray (608) can be moved to the left so that the objective pick up arm (612) is underneath the objective lens (614C) (see FIG. 11A). Once the objective carrier tray (608) is underneath the objective lens (614C), the pick up arm (612) can be lifted upwards (see FIG. 11B) so that objective lens (614C) can be used to view cells in the flow cell.

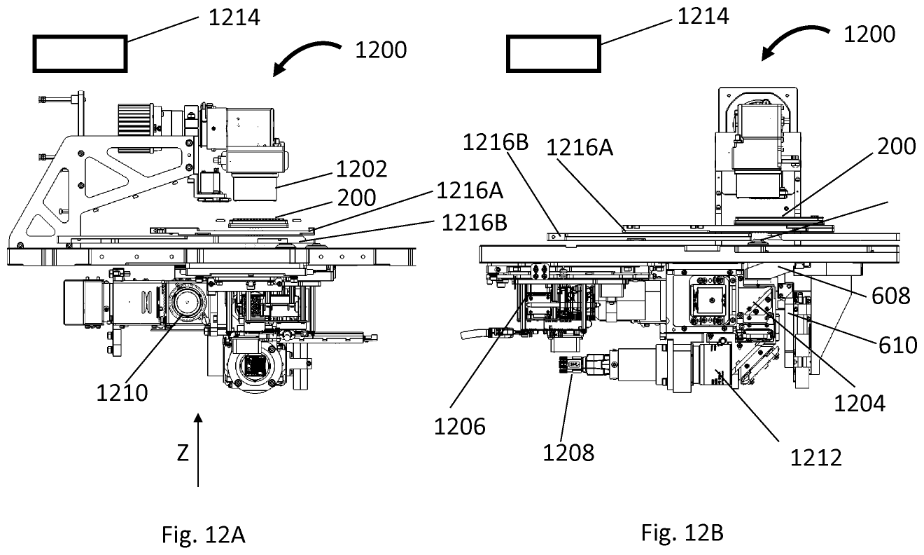

For reference, the compound objective lens assembly (600) can be used in instrument (1200) that is shown in FIG. 12A and FIG. 12B. The instrument includes a computer (1214), a brightfield illumination source (1202), a beam splitter for the objective (1204), a DMD (1206), a detector (1208), an excitation light source (1210), and collimating optics (1212). In various embodiments, detector (1208) can be used as a camera to image the cells in flow cell (200). A portion of the objective lens assembly (600) can be viewed in FIG. 12B where the components, such as the objective carrier tray (608), objective focusing stage (610), and one of the objective lenses (614), are depicted. Flow cell (200) can be placed in instrument (1200) so that images of a portion of the flow cell can be recorded with a detector (1208). An XY stage (1216) can be incorporated into the instrument to move flow cell (200) in the X and Y direction so that a relevant portion of the flow cell can be viewed using the objective lens assembly described herein. FIG. 12 A and FIG. 12B illustrate an X stage (1216A) configured to move the flow cell (200) along the x-axis and a Y stage (1216B) configured to move the flow cell (200) along the Y-axis. X stage (1216A) and Y stage (1216B) cooperate together to form XY stage (1216). In some embodiments, excitation light source (1210) can be used to identify particular cells based on fluorescent intensity resulting from a binding of a selective fluorescent reagent. DMD (1206) can be used to create photopolymerized hydrogel cages that capture particular cells of interest based on prior images captured with detector (1208).

The compound objective lens assembly (600) described herein provide several advantages over other prior lens assembly such as rotary assemblies. With respect to switching of the objective lenses, only one objective lens is lifted upwards along the Z-axis without the objective carrier tray (608), that is in contrast to other assemblies, where all of the objective lenses and a rotary turret need to be moved up or down in concert along the Z-axis. As such, the payload requirement for the objective focusing stage (610) is reduced and, in turn, reduces the cost of objective focusing stage. For the compound objective lens assembly described herein, the mounting interface for all three objective lenses is the same causing the optical alignment process to be simplified. The same project pick up arm does not move along the X-axis and the Y-axis, and mounts to each of the objective lenses in a precise manner with assistance from the lateral datum bracket and the bias element. In addition, the objective lens assembly has a compact size and a linear mechanism for selecting one of the objective lenses in comparison to a rotary objective lens assembly. The compact size reduces the likelihood of the objective lens assembly interfering with other optical components like the beam splitter (1204) and an XY stage (1216).

In some embodiments, methods and systems for single cell analysis employing reagent delivery subsystems comprise (a) providing a fluidic device comprising (i) a channel comprising an inlet, an outlet and a first surface having one or more cells disposed thereon, and wherein the inlet of the channel is in fluid communication with an inlet reservoir and the outlet of the channel is in fluid communication with a pump that draws or moves predetermined volumes of liquid in the inlet reservoir into the channel under programmed control; (b) loading the channel with an assay reagent in contact with atmosphere by transferring to the inlet reservoir a volume comprising the assay reagent; (c) sealingly attaching a pressure manifold to the inlet reservoir to pressurize the assay reagent at a predetermined pressure; and (d) drawing the assay reagent through the channel with the pump, so that the assay reagent combines with the one or more cells disposed on the first surface of the channel. In some embodiments, such methods further include incubating the one or more cells and the assay reagent for a predetermined time. In some embodiments, such assay reagent is a cell lysing reagent, a transcription reagent, a polynucleotide amplification reagent.

In some embodiments, methods and systems for single cell analysis employing reagent delivery subsystems comprise (a) providing a fluidic device comprising (i) a channel comprising an inlet, an outlet and a first surface, (ii) a spatial energy modulating element in optical communication with the first surface, (iii) a detector that identifies positions of one or more cells in the channel based on one or more optical signals therefrom, wherein the inlet of the channel is in fluid communication with an inlet reservoir and the outlet of the channel is in fluid communication with a pump that draws under programmed control predetermined volumes of liquid in the inlet reservoir through the channel; (b) loading the channel with one or more cells by transferring to the inlet reservoir a volume of a mixture of one or more cells and one or more polymer precursors, sealingly attaching a pressure manifold to the inlet reservoir to pressurize the mixture at a predetermined pressure, and drawing the mixture through the channel with the pump at a predetermined rate, so that cells of the mixture are disposed on the first surface of the channel; (c) synthesizing one or more chambers in the channel, such that each chamber encloses a single cell of the one or more cells, by projecting light into the channel with the spatial energy modulating element such that the projected light causes cross-linking of the one or more polymer precursors to form polymer matrix walls of the chambers, wherein the position of each of the synthesized chambers on the first surface is determined by the position of a cell enclosed thereby identified by the detector.

In some embodiments, methods and systems for single cell analysis employing reagent delivery subsystems comprise (a) providing a fluidic device comprising (i) a channel comprising an inlet, an outlet and a first surface having one or more cells disposed thereon, (ii) a spatial energy modulating element in optical communication with the first surface, (iii) a detector that identifies positions of one or more cells in the channel based on one or more optical signals therefrom, wherein the inlet of the channel is in fluid communication with an inlet reservoir and the outlet of the channel is in fluid communication with a pump that draws under programmed control predetermined volumes of liquid in the inlet reservoir into the channel; (b) loading the channel with one or more polymer precursors by transferring to the inlet reservoir a volume of a liquid comprising the one or more polymer precursors, sealingly attaching a pressure manifold to the inlet reservoir to pressurize the liquid at a predetermined pressure, drawing the liquid through the channel with the pump, so that the one or more polymer precursors combine with the one or more cells disposed on the first surface of the channel; (c) synthesizing one or more chambers in the channel, such that each chamber encloses a single cell of the one or more cells, by projecting light into the channel with the spatial energy modulating element such that the projected light causes cross-linking of the one or more polymer precursors to form polymer matrix walls of the chambers, wherein the position of each of the synthesized chambers on the first surface is determined by the position of a cell enclosed thereby identified by the detector.

In some embodiments, a method of delivering reagents to a cell analysis system comprises providing a fluidic device where the fluidic device includes (i) a channel comprising an inlet and an outlet; (ii) a spatial energy modulating element in optical communication with the channel; (iii) a detector that identifies positions of one or more cells in the channel based on one or more optical signals therefrom, wherein the inlet of the channel is in fluid communication with an inlet reservoir, and wherein the outlet of the channel is in fluid communication with a pump configured to move predetermined volumes of a liquid from the inlet reservoir through the channel; loading the inlet reservoir with a mixture of the one or more cells and one or more polymer precursors; sealingly attaching a pressure manifold to the inlet reservoir to pressurize the mixture to an elevated pressure greater than an ambient pressure; and moving the mixture into the channel with the pump so that the one or more cells of the mixture are disposed in the channel; synthesizing one or more chambers in the channel, such that each chamber encloses a single cell of the one or more cells, by projecting light into the channel with the spatial energy modulating element such that the projected light causes cross-linking of the one or more polymer precursors to form polymer matrix walls of the chambers, wherein a location for each of the synthesized chambers is determined by the position identified by the detector.

In regard to certain embodiments, the mixture comprises a first liquid, wherein after the synthesizing the one or more chambers in the channel, a portion of the one or more cells are disposed in an interstitial space outside of the chambers, the method further comprising: loading the inlet reservoir with a second liquid; sealingly attaching the pressure manifold to the inlet reservoir to pressurize the second liquid to the elevated pressure greater than the ambient pressure, and moving the second liquid into the channel with the pump, so that a fraction of cells disposed in the interstitial space flows out of the channel via the outlet.

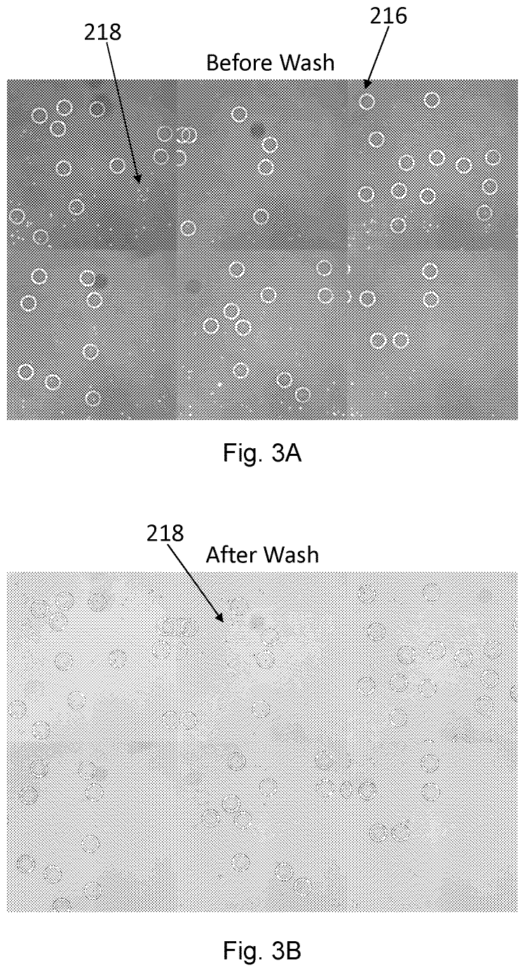

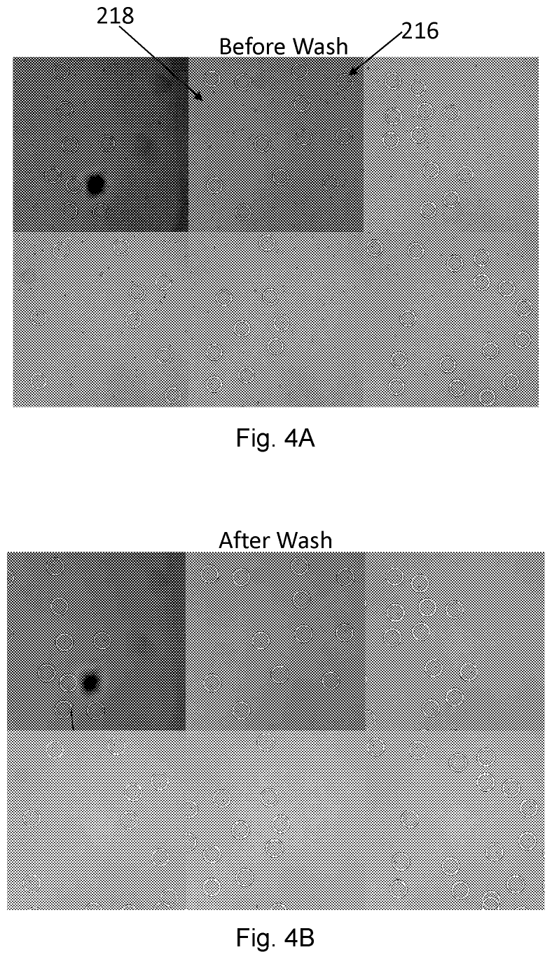

In regard to certain embodiments, the fraction of cells in the interstitial space ranges from about 50% to 100%. FIG. 3A shows various cells where some are caged into hydrogel structures (216) and other cells (e.g., 218) are not caged and reside in the interstitial space in between the hydrogel structures. FIG. 3B shows the channel after flushing with a second liquid where the pressure manifold was not used to pressurize the second liquid and only the pump was used to move the liquid by pulling liquid from the outlet. FIG. 3B shows that a significant amount of remaining cells (e.g., 218) are in the interstitial space compared to FIG. 3A before washing of the channel. FIG. 4A shows various cells where some are caged into hydrogel structures (216) and other cells (e.g., 218) are not caged and reside in the interstitial space in between the hydrogel structures. FIG. 4B shows the channel after flushing with a second liquid where the pressure manifold was used to pressurize the second liquid while the pump was used to move the liquid by pulling liquid from the outlet. FIG. 4B shows that a relatively small amount of remaining cells are in the interstitial space, which contrasts to the higher amount of remaining cells where no pressure manifold was used as shown in FIG. 3B. It should be noted that cells and hydrogel structures, under certain conditions, can be fragile with respect to flowing liquids and that the flushing with the pressure manifold and the pump pulling liquid from the outlet resulted in benign conditions that did not perturb the hydrogel and at the same time resulted in an efficient removal of interstitial cells.

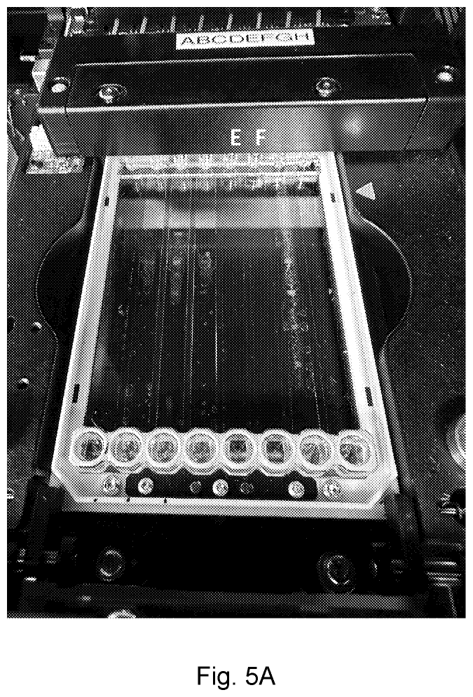

In some embodiments a method for incubating a liquid in a channel comprises: (a) providing the channel having an outlet and an inlet, wherein an inlet reservoir is fluidically coupled to the inlet, the channel containing a first liquid and being in fluid communication with the outlet, wherein a pump is fluidically coupled to the outlet, the pump being configured to move the liquid through the channel; (b) attaching to the inlet reservoir a pressure manifold that provides a pressure above atmospheric pressure to the first liquid, wherein the pump is not actuated causing the outlet to be sealed and the liquid to be quiescent. FIG. 5A shows a flow cell having channels E and F where the liquid in the channels were relatively bubble free. Channel F was pressurized with the pressure manifold at 5 PSI at the inlet reservoir and the outlet was closed for 90 minutes at 42 °C. Channel E was left at atmospheric pressure for 90 minutes at 42 °C. FIG. 5B indicates that after 90 minutes channel F remained relatively bubble free and that channel E had a plurality of bubbles 502. Thus, the channel with applied pressure from the manifold helped reduce the formation of bubbles over a time period and at elevated temperatures.

It is understood that the term “detector” as used herein may include, but not be limited by, a microscope element that collects and optionally magnifies an image of a portion of a channel and an image analysis element that comprises software for identifying cells and associated position information. A computer element uses such information generated by a detector together with user input to generate commands for other elements, such as, the spatial energy modulating element to carry out a variety of functions including, but not limited to, synthesizing chambers, “on-demand” degrading of chambers, selectively photo-degrading chambers, and the like. Configurations of such embodiments are illustrated in FIGS. 2A-2B which are described above. In some embodiments, a channel of a fluidic device further comprises a second surface wherein said first surface and the second surface are disposed opposite one another across the channel, and wherein the polymer matrix walls of the chambers extend from the first surface to the second surface to form chambers each having an interior. In some embodiments, chambers in a channel each enclose a single cell. In some embodiments both the first wall and the second wall are made of optically transmissive materials, such as, glass, plastic, or the like, and are positioned so that the first surface and second surface are substantially parallel to one another. The perpendicular distance between a first surface and a second surface may be in the range of from 10 μm to 500 μm, or in the range of from 50 μm to 250 μm.

As noted above, any of first surfaces, second surfaces or polymer matrix wall of chambers may comprise capture elements and other functional groups for carrying out a variety of operations including, but not limited to, capturing beads, capturing cells, capturing analytes (such as, mRNA, secreted proteins, intracellular proteins, or genomic sequences), capturing constituents of analytical reagents (such as, oligonucleotide labels from antibodies), and the like. Derivatizing surfaces for such purposes is well-known to those skilled in the art, as evidenced by the following references: Integrated DNA Technologies brochure (cited above); Hermanson (cited above); and the like.

As noted above, in some embodiments, a fluidic device of the method comprises or is operationally associated with a detector that either may share an optical path of the spatial energy modulating element or may be disposed adjacent to the second wall or opposite the first wall from the spatial energy modulating element in embodiments, such as wells, that have only a first wall and first surface. The detector is positioned so that it is capable of detecting optical signals from or adjacent to cells in the channel, for example, distributed over the first surface in chambers. In some embodiments, the first and second walls each comprise optically transmissive material, for example, so that a spatial energy modulating element may project light energy to the interior of the channel, and so that a detector may detect optical signals, such as fluorescent emissions or reflected light from biological components. In some embodiments, the projected energy from the spatial energy modulating element is a light energy from a light beam. In some embodiments, the light beam projected by the spatial energy modulating element may have a complex cross-section that permits (in various embodiments) the simultaneous synthesis of a plurality of chambers. Optically transmissive materials include, but are not limited to, glass, quartz, plastic, and like materials.

Spatial energy modulating elements using light energy for polymerization may comprise physical photomasks or virtual photomask, such as, a digital micromirror device (DMD). The following references, which are hereby incorporated by reference, provide guidance in selecting and operating a DMD for photopolymerizing gels: Chung et al, U.S. Pat. No. 10,464,307; Hribar et al, U.S. Pat. No. 10,351,819; Das et al, U.S. Pat. No. 9,561,622; Huang et al, Biomicrofluidics, 5: 034109 (2011); and the like.

### Gel Chambers

Methods and apparatus of Khurana et al may employ a wide variety of photo-synthesizable gels and degradable gels for cellular analysis. Guidance for selecting such gels for desired properties including, but not limited to, biocompatibility, porosity, gelation speed, degradation speed, and like properties, is provided in the following references, which are incorporated by reference: Kharkar et al, Chem. Soc. Rev., 42:7335-7372 (2013); Kharkar et al, Polymer Chem., 6(31): 5565-5574 (2015); Neumann et al, Acta Biomater., 39:1-11 (2016); DeForest et al, Nature Chemistry, 3(12): 925-931 (2012); Bowman et al, U.S. Pat. No. 9,631,092;LeValley et al, ACS Appl. Bio. Mater., 3(10): 6944-6958 (2020); Kabb et al, ACS Appl. Mater. Interfaces, 10:16793-16801 (2018); Fairbanks et al, Macromolecules, 44:2444-2450 (2011); Fairbanks et al, Adv. Mater., 21(48): 5005-5010 (2009); Sugiura et al, U.S. patent publication US2016/0177030; Shih et al, Biomacromolecules, 13(7): 2003-2012 (2012); and the like. In some embodiments, photo-synthesized gels are formed using a photo-initiator for radical polymerization. In some embodiments, photo-initiators comprise Irgacure 2959, Lithium phenyl-2,4,6-trimethylbenzoylphosphinate (LAP), or Eosin-Y (e.g. see Choi et al, Biotechniques, 66(1): 40-53 (2019)). In some embodiments, hydrogel precursors comprise hyaluronic acid, chitosan, heparin, alginate, polyethylene glycol (PEG), multi-arm PEG, poly(ethylene glycol)-b-poly(propylene oxide)-b-poly(ethylene glycol) (PEG-PPO-PEG), poly(lactic acid-co-glycolic acid)-b-poly(ethylene glycol)-b-poly(lactic acid-co-glycolic acid) (PLGA-PEG-PLGA), and poly(vinyl alcohol). In some embodiments, polymer precursors comprise PEG or multi-arm PEG. In some embodiments, polymer precursors comprise an enzymatically degradable cross-linker. In some embodiments, such enzymatically degradable cross-linker is degradable by an esterase or a peptidase. In some embodiments, polymer precursors comprise a photo-degradable cross-linker. In some embodiments, such photo-degradable cross-linker comprises a nitrobenzyl group. In some embodiments, such photo-degradable cross-linker comprises a coumarin moiety. In some embodiments, photo-degradable hydrogels are used with methods described herein, for example, because photo-degradation of hydrogel chambers may be carried out selectively and on-demand, so that specified hydrogel chambers may be degraded without affecting non-selected hydrogel chambers are unaffected. In some embodiments, hydrogel chambers are degraded non-selectively, so that all hydrogel chambers in a given channel (or other vessel) are degraded simultaneously. In some embodiments, such non-selective degradation is carried out with a cleavage reagent that specifically cleaves a labile bond in a hydrogel. For example, such cleavage agent comprises a reducing agent. In some embodiments, such non-specific degradation is carried out with an enzyme that cleaves a bond or chemical element in a hydrogel. Chemical elements include, but are not limited to, peptides, polysaccharides and oligonucleotides.

In the figures, for convenience, hydrogel chambers are illustrated as standing in isolation without connection with adjacent chambers and as having a cylindrical or annular-like shapes; however, a spatial energy modulating element may synthesize chambers of different shapes and sizes, as is useful for particular applications. In some embodiments of the proliferation assay, each hydrogel chamber synthesized has the same shape and area, for example, annular-like with an interior area selected from the range of 0.001 to .01 mm².

Porosity. In some embodiments, hydrogel porosity is selected to permit passage of selected reagents while at the same time preventing the passage of other reagents or objects, such as, a cell or proteins of a lysed cell. In some embodiments, crosslinking the polymer chains of the hydrogel structure forms a hydrogel matrix having pores (i.e., a porous hydrogel matrix). In some embodiments, the pores have an average diameter of from about 2 nm to about 25 nm, or from about 5 nm to about 20. In some embodiments, average pore diameters are selected to prevent the passage of cellular proteins. In some embodiments, average pore diameters are selected to prevent the passage of cellular proteins having a molecular weight of 1 kiloDaltons or greater. In some embodiments, average pore diameters are selected to prevent the passage of cellular proteins having a molecular weight of 5 kiloDaltons or greater. In some embodiments, the pore size of the hydrogel structures is tuned by varying the ratio of the concentrations of polymer precursors to the concentration of crosslinkers, varying pH, salt concentrations, temperature, light intensity, and the like. Guidance for selecting materials and conditions to control hydrogel porosity may be found in the following references: Jung et al, Biochem. Eng. J., 135:123-132 (2018); Winther et al, Biochim. Biophys. Acta, 1840(2): doi: 10.1016/j. bbagen.3013.03.031 (2014); Annabi et al, Tissue Engineering, part B, 16(4): 371-383 (2010); and the like.

Size and Shape of Hydrogel Chambers. In some embodiments, a polymer matrix wall of a chamber inhibits passage of a predetermined component, such as a mammalian cell, a bacterial cell, or proteins from a lysed cell. In some embodiments, a polymer matrix wall extends from the first surface to a second surface (parallel to the first surface) to form a chamber within a channel. In some embodiments, a chamber has polymer matrix walls and an interior. In some embodiments, the interior of a chamber is sized for enclosing a cell, such as a mammalian cell. For example, such chamber may comprise a cylindrical shell or a polygon shell, comprising an inner space, or interior and a polymer matrix wall. In some embodiments, such chambers may have annular-like cross-sections. As used herein, the term “annular-like cross-section” means a cross-section topologically equivalent to an annulus. In some embodiments, the inner space, or interior, of a chamber has an inner diameter from 1 μm to 500 μm and a volume in the range of from 1 pico liter to 200 nano liters, or from 100 pico liters to 100 nano liters, or from 100 picoliters to 10 nano liters. In some embodiments, the polymer matrix wall has a thickness of at least 1 μm (micrometer). In some embodiments, the height of a chamber with an annular-like cross section have a value in the range of from 10 μm to 500 μm, or in the range of from 50 μm to 250 μm. In some embodiments, a polymer matrix wall having an annular-like cross-section has an aspect ratio (i.e., height/width) of 1 or less. In some embodiments, aspect ratio and polymer matrix wall thickness are selected to maximize chamber stability against forces, such as reagent flow through the channel, washings, and the like. In some embodiments, the at least one polymer matrix wall is a hydrogel wall. In some embodiments, the at least one polymer matrix is degradable. In some embodiments, the degradation of the at least one polymer matrix is “on demand.” In some embodiments, chambers in a channel are non-contiguous. In some embodiments, chambers in a channel may be contiguous with adjacent chambers. In some embodiments, chambers may share polymer matrix walls with one another. In some embodiments, chambers may be synthesized with slits or other orifices large enough to permit passage of certain components, e.g. beads, but small enough to prevent passage of other components, e.g. cells.

Hydrogel Compositions. As mentioned above, hydrogel compositions may vary widely and hydrogels may be formed by a variety of methods. Biocompatible hydrogel precursors comprise, but are not limited to, hyaluronic acid, chitosan, heparin, alginate, polyethylene glycol (PEG), multi-arm PEG, poly(ethylene glycol)-b-poly(propylene oxide)-b-poly(ethylene glycol) (PEG-PPO-PEG), poly(lactic acid-co-glycolic acid)-b-poly(ethylene glycol)-b-poly(lactic acid-co-glycolic acid) (PLGA-PEG-PLGA), and poly(vinyl alcohol). In some embodiments, hydrogels are formed by photo-initiated free radical crosslinking. In some embodiments, hydrogels are formed by photo-initiated thiol-ene reactions.

Hydrogel Degradation. In some embodiments, hydrogel chambers are degradable or depolymerizable either generally within a channel or “on demand” within a channel. Hydrogel chambers that are generally degradable are degraded by treatment with a degradation agent, or equivalently, a depolymerization agent that is exposed to all chambers within channel. Depolymerization agents include, but are not limited to, heat, light, and/or chemical depolymerization reagents (also sometimes referred to a cleaving reagents or degradation reagents). In some embodiments, on demand degradation may be implemented using polymer precursors that permit photo-crosslinking and photo-degradation, for example, using different wavelengths for crosslinking and for degradation. For example, Eosin Y may be used for radical polymerization at defined regions using 500 nm wavelength, after which illumination at 380 nm can be used to cleave the cross linker. In other embodiments, photo-caged hydrogel cleaving reagents may be included in the formation of polymer matrix walls. For example, acid labile crosslinkers (such as esters, or the like) can be used to create the hydrogel and then UV light can be used to generate local acidic conditions which, in turn, degrades the hydrogel. In some embodiments, the at least one polymer matrix is degradable by at least one of: (i) contacting the at least one polymer matrix with a cleaving reagent; (ii) heating the at least one polymer matrix to at least 90 °C; or (iii) exposing the at least one polymer matrix to a wavelength of light that cleaves a photo-cleavable cross linker that cross links the polymer of the at least one polymer matrix. In some embodiments, the at least one polymer matrix comprises a hydrogel. In some embodiments, the cleaving reagent degrades the hydrogel. In some embodiments, the cleaving reagent comprises a reducing agent, an oxidative agent, an enzyme, a pH based cleaving reagent, or a combination thereof. In some embodiments, the cleaving reagent comprises dithiothreitol (DTT), tris(2-carboxyethyl)phosphine (TCEP), tris(3-hydroxypropyl)phosphine (THP), or a combination thereof. In some embodiments, the surface of the polymer matrix or hydrogel may be functionalized by coupling a functional group to the polymer matrix or hydrogel.

While the methods and systems have been described herein with reference to several particular example embodiments, those skilled in the art will recognize that many changes may be made thereto without departing from the spirit and scope of the present disclosure. The methods and systems described herein can be applicable to a variety of sensor implementations and other subject matter, in addition to those discussed above.

### Definitions

Unless otherwise specifically defined herein, terms and symbols of nucleic acid chemistry, biochemistry, genetics, and molecular biology used herein follow those of standard treatises and texts in the field, e.g. Kornberg and Baker, DNA Replication, Second Edition (W.H. Freeman, New York, 1992); Lehninger, Biochemistry, Second Edition (Worth Publishers, New York, 1975); Strachan and Read, Human Molecular Genetics, Second Edition (Wiley-Liss, New York, 1999); Abbas et al, Cellular and Molecular Immunology, 6^{th} edition (Saunders, 2007).

“Assay” refers to a process for detecting or measuring a cellular characteristic or property of single cells or of a population of cells. Typically process steps of an assay comprise a chemical, biochemical or molecular reaction (such as a cleavage of a bond, specific binding of complementary components, enzyme reactions, dissolution of complementary components, or the like) or a change of physical state (such as an increase or decrease in temperature, change in energy level, or the like) and result in the generation of a signal (or signals) from which the presence, absence or magnitude of a quantity related to a cell may be inferred. The nature of the signal produced by an assay may vary widely and can include, but is not limited to, an electrical signal, an optical signal, a chemical signal, or a material signal. A material signal comprises the production of a material that comprises information that can be extracted. For example, a material signal may be the amplification of a polynucleotide whose length, quantity, composition, or nucleotide sequence is indicative of a cellular characteristic. For example, a barcode oligonucleotide may be a material signal. Characteristics or properties of cells that are detected or measured may vary widely and include, but are not limited to, cytotoxicity, viability, proliferation capacity under selected conditions, size, shape, motility, types and profiles of cell surface, or cell membrane proteins, types and profiles of secreted proteins, production of metabolites, transcriptome, gene copy numbers, gene or allele identity, chromatin accessibility profiles, vector copy numbers for engineered or infected cells, and the like. Assays of special interest for cell-based therapy include, but are not limited to, cytotoxicity, viability, activation, proliferation capacity under selected conditions, chromatin accessibility profiles, types and profiles of cell surface or membrane proteins, types and profiles of secreted proteins, intracellular proteins, transcriptome, vector copy number, and the like. As used herein, an “assay reagent” is a liquid used in an assay. An assay reagent may include, but is not limited to, a pH buffered solution, an enzyme buffer solution with or without an enzyme, a molecular or cellular stain or dye, a lysing agent, a gel degradation reagent, a suspension of cells, a salt solution, a wash solution, cellular growth media, or the like.

“Cells” refers to biological cells that may be assayed by methods and systems described herein comprise, but are not limited to, vertebrate, non-vertebrate, eukaryotic, mammalian, microbial, protozoan, prokaryotic, bacterial, insect, or fungal cells. In some embodiments, mammalian cells are assayed by methods and systems described herein. In particular, any mammalian cell which may be, or has been, genetically altered for use in a medical, industrial, environmental, or remedial process, may be analyzed by methods and systems described herein. In some embodiments, “cells” as used herein comprise genetically modified mammalian cells. In some embodiments, “cells” comprise stem cells. In some embodiments, “cells” refer to cells modified by CRISPR Cas9 techniques. In some embodiments, “cells” refer to cells of the immune system including, but not limited to, cytotoxic T lymphocytes, regulatory T cells, CD4+ T cells, CD8+ T cells, natural killer cells, antigen-presenting cells, or dendritic cells. Of special interest are cytotoxic T lymphocytes engineered for therapeutic applications, such as cancer therapy.

“Hydrogel” means a gel comprising a crosslinked hydrophilic polymer network with the ability to absorb and retain large amounts of water (for example, 60 to 90 percent water, or 70 to 80 percent) without dissolution due to the establishment of physical or chemical bonds between the polymeric chains, which may be covalent, ionic or hydrogen bonds. Hydrogels exhibit high permeability to the oxygen and nutrients, making them attractive materials for cell encapsulation and culturing applications. Hydrogels may comprise natural or synthetic polymers and may be reversible (i.e. degradable or depolymerizable) or irreversible. Synthetic hydrogel polymers can include polyethylene glycol (PEG), poly(2-hydroxyethyl methacrylate) and poly(vinyl alcohol). Natural hydrogel polymers can include alginate, hyaluronic acid and collagen. The following reference describe hydrogels and their biomedical uses: Drury et al, Biomaterials, 24:4337-4351 (2003); Garagorri et al, Acta Biomatter, 4(5): 1139-1147 (2008); Caliari et al, Nature Methods, 13(5): 405-414 (2016); Bowman et al, U.S. Pat. No. 9,631,092; Koh et al, Langmuir, 18(7): 2459-2462 (2002).

“Polymer matrix” generally refers to a phase material (e.g. continuous phase material) that comprises at least one polymer. In some embodiments, the polymer matrix refers to the at least one polymer as well as the interstitial space not occupied by the polymer. A polymer matrix may be composed of one or more types of polymers. A polymer matrix may include linear, branched, and crosslinked polymer units. A polymer matrix may also contain non-polymeric species intercalated within its interstitial spaces not occupied by polymer chains. The intercalated species may be solid, liquid, or gaseous species. For example, the term “polymer matrix” may encompass desiccated hydrogels, hydrated hydrogels, and hydrogels containing glass fibers. A polymer matrix may comprise a polymer precursor, which generally refers to one or more molecules that upon activation can trigger or initiate a polymeric reaction. A polymer precursor can be activated by electrochemical energy, photochemical energy, a photon, magnetic energy, or any other suitable energy. As used herein, the term “polymer precursor” includes monomers (that are polymerized to produce a polymer matrix) and crosslinking compounds, which may include photo-initiators, other compounds necessary or useful for generating polymer matrices, especially polymer matrices that are hydrogels.

While preferred embodiments of the systems and methods described herein have been shown and described herein, it will be obvious to those skilled in the art that such embodiments are provided by way of example only. It is not intended that the systems and methods described herein be limited by the specific examples provided within the specification. While the systems and methods described herein have been described with reference to the aforementioned specification, the descriptions and illustrations of the embodiments herein are not meant to be construed in a limiting sense. Numerous variations, changes, and substitutions will now occur to those skilled in the art without departing from the systems and methods described herein. Furthermore, it shall be understood that all aspects of the systems and methods described herein are not limited to the specific depictions, configurations or relative proportions set forth herein which depend upon a variety of conditions and variables. It should be understood that various alternatives to the embodiments of the systems and methods described herein may be employed in practicing the systems and methods described herein. It is therefore contemplated that the systems and methods described herein shall also cover any such alternatives, modifications, variations or equivalents. It is intended that the following claims define the scope of the systems and methods described herein and that methods and structures within the scope of these claims and their equivalents be covered thereby.

What is claimed is:

1. A microscope objective lens assembly, comprising:
(a) a plurality of objective lenses, wherein each of the objective lenses of the plurality of objective lenses have a different magnification power;
(b) an objective carrier tray configured to:
(i) hold the plurality of objective lenses, and
(ii) couple to a rail;
(c) an objective pickup arm configured to:
(i) couple to an objective lens of the plurality of objective lenses, and
(ii) move between a lowered state and a lifted state while coupled to the objective lens; and
(d) a motor operationally coupled to the objective carrier tray to move the objective carrier tray along the rail.

2. The microscope objective lens assembly of claim 1, wherein the objective carrier tray is configured to move along the rail with respect to the objective pickup arm.

3. The microscope objective lens assembly of claim 1, further comprising an objective focusing stage configured to move the objective pickup arm between the lowered state and the lifted state.

4. The microscope objective lens assembly of claim 1, wherein the rail is linear.

5. The microscope objective lens assembly of claim 1, wherein the objective pickup arm raises upwards by a predetermined distance when transitioning from the lowered state and the lifted state.

6. The microscope objective lens assembly of claim 1, wherein the objective pickup arm comprises a hole configured to allow light to transmit through the objective pickup arm and the objective lens coupled thereto.

7. The microscope objective lens assembly of claim 1, wherein the objective pickup arm comprises a lateral datum bracket, wherein the lateral datum bracket is configured to align the objective lens to a registered location, wherein the objective lens comprises an objective adapter plate, wherein the objective adapter plate comprises a feature configured to cooperate with a receiving feature of the lateral datum bracket to align the objective lens.

8. The microscope objective lens assembly of claim 7, wherein the objective pickup arm comprises a magnet, and wherein the objective adapter plate comprises a metal configured to bind to the magnet.

9. The microscope objective lens assembly of claim 7, wherein the objective adapter plate comprises a magnet configured to bind to a metal portion of the objective pickup arm.

10. The microscope objective lens assembly of claim 1, wherein the motor is not operationally coupled to the objective pickup arm.

11. A flow cell system, comprising:
(A) a flow cell configured to receive a plurality of cells, the flow cell comprising: a first optically transparent surface, a second optically transparent surface, and a spacer layer comprising a cut-out region,
wherein the first optically transparent surface, the second optically transparent surface, and the cut-out region form a flow channel, and wherein the flow channel comprises an inlet and an outlet;
(B) an illumination source configured to output light to the flow cell; and
(C) a detector configured to receive the light from the flow cell, wherein the detector comprises a microscope objective lens assembly, the microscope objective lens assembly comprising:
(a) a plurality of objective lenses, wherein each of the objective lenses of the plurality of objective lenses have a different magnification power;
(b) an objective carrier tray configured to:
(i) hold the plurality of objective lenses, and
(ii) couple to a rail;
(c) an objective pickup arm configured to:
(i) couple to an objective lens of the plurality of objective lenses,
(ii) move between a lowered state and a lifted state while coupled to the objective lens; and
(d) a motor operationally coupled to the objective carrier tray to move the objective carrier tray along the rail.

12. The flow cell system of claim 11, wherein the objective carrier tray is configured to move along the rail with respect to the objective pickup arm.

13. The flow cell system of claim 11, wherein the microscope objective lens assembly further comprises an objective focusing stage configured to move the objective pickup arm between the lowered state and the lifted state.

14. The flow cell system of claim 11, wherein the rail is linear.

15. The flow cell system of claim 13, wherein the objective pickup arm raises upwards by a predetermined distance when transitioning from the lowered state and the lifted state.

16. The flow cell system of claim 11, wherein the objective pickup arm comprises a hole configured to allow light to transmit through the objective pickup arm and the objective lens coupled thereto.

17. The flow cell system of claim 11, wherein the objective pickup arm comprises a lateral datum bracket, wherein the lateral datum bracket is configured to align the objective lens to a registered location, wherein the objective lens comprises an objective adapter plate, wherein the objective adapter plate comprises a feature configured to cooperate with a receiving feature of the lateral datum bracket to align the objective lens.

18. The flow cell system of claim 11, wherein the illumination source is disposed on a first side of the flow cell, wherein the microscope objective lens assembly is disposed on a second side of the flow cell, and wherein the second side of the flow cell opposes the first side of the flow cell.

19. The flow cell system of claim 15, wherein the objective focusing stage is further configured to move the objective pickup arm a focusing distance closer or farther away from a cell of the plurality of cells in the flow cell while in the lifted state, and wherein the predetermined distance is greater than the focusing distance.

20. The flow cell system of claim 11, wherein the motor is not operationally coupled to the objective pickup arm.
